(19) United States
(12) Patent Application Publication
(10) Pub. No.: US 2010/0299154 A1
(43) Pub. Date: Nov. 25, 2010

(54) Intelligent computer-biological electronic-neural health-care system

(76) Inventor: Anuthep Benja-Athon, New York, NY (US)

Correspondence Address: ANUTHEP BENJA-ATHON, 210 E 36th St., NEW YORK, NY, 10016, US

(21) Appl. No.: 12/804,588

(22) Filed: Jul. 26, 2010

Related U.S. Application Data
(63) Continuation-in-part of application No. 12/799,207, filed on Apr. 21, 2010.
Application No. 12/799,207 is a continuation-in-part of application No. 12/658,112, filed on Feb. 3, 2010.
Application No. 12/658,112 is a continuation-in-part of application No. 12/655,748, filed on Jan. 7, 2010.
Application No. 12/655,748 is a continuation-in-part of application No. 12/592,714, filed on Dec. 2, 2009.
Application No. 12/592,714 is a continuation-in-part of application No. 12/381,654, filed on Mar. 16, 2009.
Application No. 12/381,654 is a continuation-in-part of application No. 12/322,529, filed on Feb. 4, 2009.
Application No. 12/322,529 is a continuation-in-part of application No. 12/321,141, filed on Jan. 16, 2009.
Application No. 12/321,141 is a continuation-in-part of application No. 12/080,433, filed on Apr. 3, 2008.
Application No. 12/080,433 is a continuation-in-part of application No. 12/069,409, filed on Feb. 11, 2008.
Application No. 12/069,409 is a continuation-in-part of application No. 11/986,657, filed on Nov. 26, 2007, now abandoned.
Application No. 11/986,657 is a continuation-in-part of application No. 11/803,621, filed on May 16, 2007.
Application No. 11/803,621 is a continuation-in-part of application No. 11/716,062, filed on Mar. 9, 2007, now abandoned.
Application No. 11/716,062 is a continuation-in-part of application No. 11/649,873, filed on Jan. 5, 2007, now abandoned.
Application No. 11/649,873 is a continuation-in-part of application No. 11/637,662, filed on Dec. 13, 2006, now abandoned.
Application No. 11/637,662 is a continuation-in-part of application No. 11/599,847, filed on Nov. 16, 2006, now abandoned.
Application No. 11/599,847 is a continuation-in-part of application No. 11/431,046, filed on May 10, 2006, now abandoned.
Application No. 11/431,046 is a continuation-in-part of application No. 11/543,895, filed on Oct. 6, 2006, now abandoned.
Application No. 11/543,895 is a continuation-in-part of application No. 11/523,945, filed on Sep. 21, 2006, now abandoned.
Application No. 11/523,945 is a continuation-in-part of application No. 11/510,820, filed on Aug. 28, 2006, now abandoned.
Application No. 11/510,820 is a continuation-in-part of application No. 11/477,121, filed on Jun. 29, 2006, now abandoned.
Application No. 11/477,121 is a continuation-in-part of application No. 11/114,763, filed on Apr. 27, 2005, now abandoned.
Application No. 11/114,763 is a continuation-in-part of application No. 11/196,823, filed on Aug. 4, 2005, now abandoned.
Application No. 11/196,823 is a continuation-in-part of application No. 11/973,866, filed on Oct. 11, 2007, now abandoned.
Application No. 11/973,866 is a continuation-in-part of application No. 11/293,689, filed on Dec. 5, 2005, now abandoned.
Application No. 11/293,689 is a continuation-in-part of application No. 11/150,878, filed on Jun. 13, 2005, now abandoned.
Application No. 11/150,878 is a continuation-in-part of application No. 11/074,236, filed on Mar. 7, 2005, now abandoned.
Application No. 11/074,236 is a continuation-in-part of application No. 11/022,410, filed on Dec. 27, 2004, now abandoned.
Application No. 11/022,410 is a continuation-in-part of application No. 09/191,795, filed on Nov. 13, 1998, now Pat. No. 6,132,218.

(51) Int. Cl. G06Q 50/00; G06Q 10/00; G06F 17/30

(52) U.S. Cl. 705/2; 707/769; 707/E17.014

(57) ABSTRACT

An adaptable computer server-intelligent system and method for computer server-deducing precise information on physicians' identities and practices and individual diagnoses and related treatments and differential diagnoses in responding to individual queries for said information from people using computers and mobile communication devices.

This application is a continuation-in-part of Ser. No. 12/799,207 entitled Computer-created-consensus-based health-care system filed Apr. 21, 2010, a continuation-in-part of Ser. No. 12/658,112 entitled A system and method for computer-generations of diagnoses filed Feb. 3, 2010, a continuation-in-part of Ser. No. 12/655,748 entitled the Artificial-intelligent system and method for managing health-care filed Jan. 7, 2010, a continuation-in-part of Ser. No. 12/592,714 entitled the Healthcare Exchange IV filed Dec. 2, 2009, a continuation-in-part of Ser. No. 12/381,654 filed Mar. 16, 2009 entitled the Adaptable compositions of health information, a continuation-in-part of Ser. No. 12/322,529 entitled the Healthcare Exchange II filed Feb. 4, 2009, a continuation-in-part of Ser. No. 12/321,141 entitled the Best system of health and health-care data management filed Jan. 16, 2009, a continuation-in-part of Ser. No. 12/080,433 entitled The Healthcare Exchange filed Apr. 3, 2008, a continuation-in-part of Ser. No. 12/069,409 entitled the Filing of Health and Health-care data filed Feb. 11, 2008, continuation-in-part of Ser. No. 11/986,657 entitled A hierarchy of medical word headers filed Nov. 26, 2007, a continuation-in-part of Ser. No. 11/803,621 entitled Patients' and physicians' data management filed May 16, 2007, a continuation-in-part of Ser. No. 11/716,062 entitled A sieve of words in health-care data filed Mar. 9, 2007, a continuation-in-part of Ser. No. 11/649,873 entitled A system of calibrating physicians' practices of medicine filed Jan. 5, 2007, a continuation-in-part of Ser. No. 11/637,662 entitled A vital hierarchy of data on diseases filed Dec. 13, 2006, a continuation-in-part of Ser. No. 11/599,847 entitled A hybrid intelligence in medicine filed Nov. 16, 2006, a continuation-in-part of Ser. No. 11/431,046 entitled A system of health-care information management filed Nov. 2, 2006, a continuation-in-part of Ser. No. 11/543,895 entitled Vital elements of speech recognition filed Oct. 6, 2006, a continuation-in-part of Ser. No. 11/523,945 entitled The networking of digital health information filed Sep. 21, 2006, a continuation-in-part of Ser. No. 11/510,820 entitled Words for managing health and health-care information filed Aug. 28, 2006, a continuation-in-part of Ser. No. 11/477,121 entitled the Medical Vocabulary Templates in Speech Recognition filed Jun. 29, 2006, a continuation-in-part of Fidelity of physicians' thoughts to digital data conversions filed Jan. 9, 2006, a continuation-in-part of Ser. No. 11/114,763 entitled A system of influencing health-care utilizations filed Apr. 27, 2005, a continuation-in-part of Ser. No. 11/196,823 entitled Routing of health information files filed Aug. 4, 2005, a continuation-in-part of Ser. No. 11/973,866 entitled An intelligent system of speech recognizing physicians' data, a continuation-in-part of Ser. No. 11/293,689 entitled A system of conserving health-care buyers' resources filed Dec. 5, 2005, a continuation-in-part of Ser. No. 11/150,878 entitled Physicians' optimal management of health information filed Jun. 13, 2005, a continuation-in-part of Ser. No. 11/074,236 entitled A system of management of health-care resources filed Mar. 7, 2005, a continuation-in-part of Ser. No. 11/022,410 entitled Physicians' way of information productions filed Dec. 27, 2004 which are pending and a continuation-in-part of U.S. Pat. No. 6,132,218 entitled Images for communication of medical information in computer granted Oct. 17, 2000 to this present patent applicant.

### FIELD OF INVENTION

A system and method for computer server-automatically deducing precise and accurate information on physicians, diagnoses, differential diagnoses and treatments.

### BACKGROUND OF THE INVENTION

The present invention is a prototype of more complex and most intelligent computer-biological electronic-neural system and method in medicine and health-care.

The current health-care system and the practice of medicine and surgery are and remain as archaic and inefficient as those in the past decades. One of the reasons is the lack of know-how for effecting an effective and practical technological innovation on the most efficient and speedy delivery and management of health, health-care and health-care services by and among physicians and people in the current tortuous health-care system.

The present invention expedites and improves medical-decision and health-care processes and the managements of health-care services and deliveries of patients to serve said people and, together with said pending patent applications, are the only means and solution for solving the current health and health-care woes affecting all Americans and, consequently, they produce the best health-care system the world ever known and have and the global benefits for billions of people including physicians and patients and humanity are immense.

The present invention stemming from a research provides an excellent system and method for people to directly and speedily interact among themselves and computer servers in the Internet of people and computer servers and modern communication devices to directly and speedily secure precise, accurate and vital information of great import on health, health-care and health-care services of said people. Furthermore, the outcomes and the derivatives of the present invention are numerous and immensely vital to humanity.

### SUMMARY OF THE INVENTION

Adverse events, conditions, settings and outcomes and medical and health consequences in the current health-care system are extremely common and pervasive in all nations including America due to the inefficiencies in the current system of health-care. Heretofore, there were no solutions to said dilemmas.

The present invention provides an adaptable computer server-intelligent system and method for computer server-deducing precise and accurate information on physicians' identities and practices and individual diagnoses and related treatments and differential diagnoses in Internet and electronic-speedily responding to individual queries for said accurate and precise information query by people using computers and mobile communication devices achievable by millions and billions of people because of a complex and most intelligent computer-biological electronic-neural system infra.

The present invention—the most perfect and efficient health-care system ever invented by human—providing an interactive system and methods for the fastest, most efficient and coordinated and least expensive managements and deliveries of health, health-care and health-care services by physicians and electronic-speedily and optimal deliveries of health, health-care and health-care services by individual physicians and individual groups of physicians and correct, optimal, coordinated and uniformly effective approaches to and choices of managements and treatments of diseases and disorders by individual physicians and individual groups of physicians and patients.

### DESCRIPTION OF THE PREFERRED EMBODIMENTS

The present invention is a prototype of more complex and most intelligent computer-biological electronic-neural system and method in medicine and health-care based on the intelligence and experiences of thousands to millions of physicians and doctors in America and the rest of the world and the queries for information on health, health-care and health-care service infra of millions to billions of people all over the world enabled by the computer sciences and technologies, equipment and computer programs and software and the Internet and a network or networks of computer servers and computers and mobile communication equipment and devices on 24×7 basis from anywhere on earth and space.

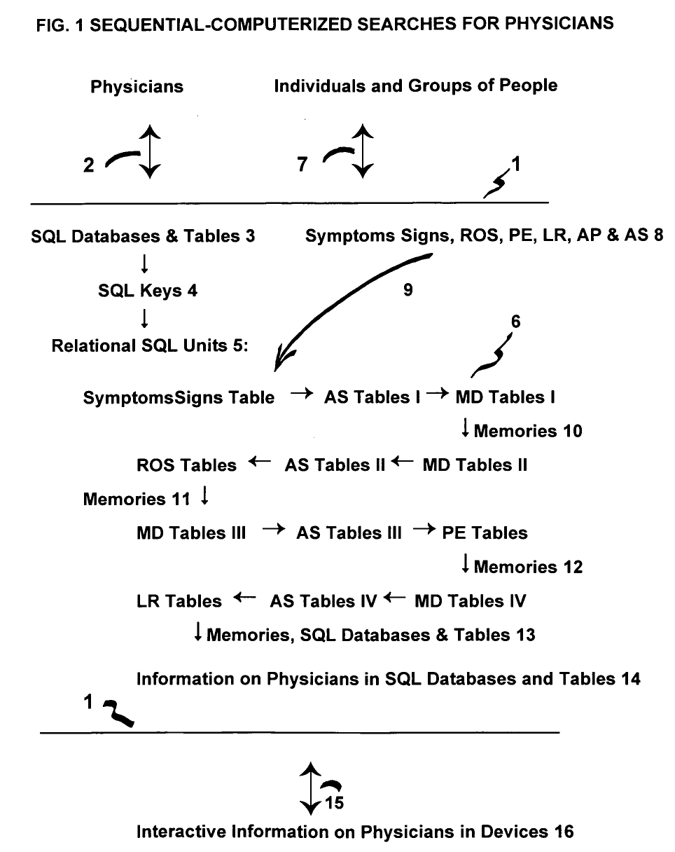

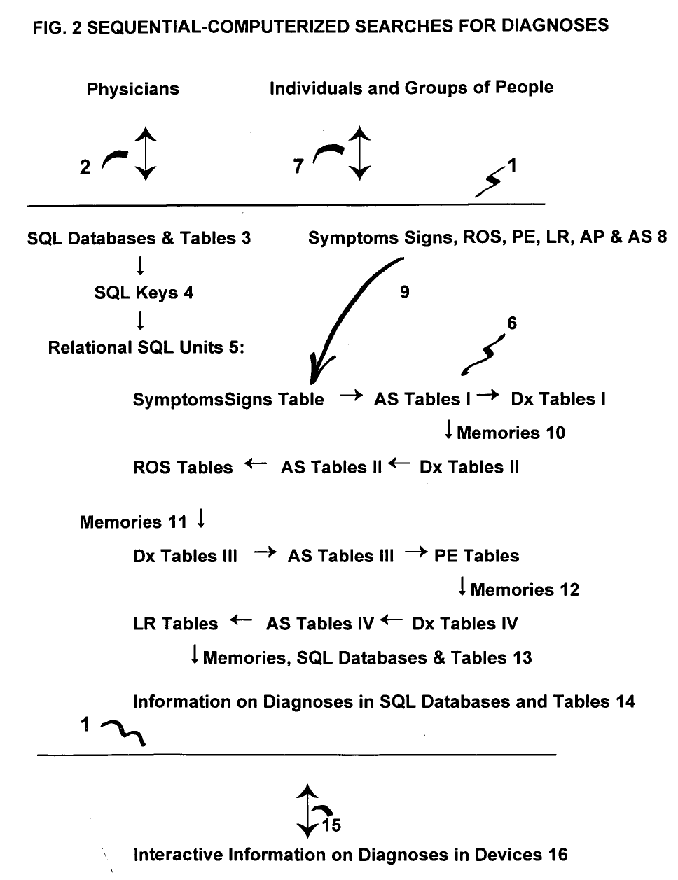

For eliminating the random, tedious and time-consuming and costly processes for searching for and referring to physicians and coordinating and managing health, health-care and health-care services among millions—billions of physicians and people and optimizing health, preventive health-care, continuity of health-care, managing chronic diseases and health-care of people, the present invention provides a system and method for computer server-automatically deducing information on individual physicians' identities such as, but not limited to, names, addresses and telephone numbers and medical and surgical expertises and practices and specialties and individual diagnoses and related treatments from said information in the relational SQL units 5—an innovation created and generated by physicians, said and in computer server or servers and the multi-versatile innovative computer programs and software infra invented by the present patent applicant and schematically represented by 5 in FIG. 1 and FIG. 2. Said individual relational SQL units comprising relational SQL keys—schematically represented by 4 in FIG. 1 and FIG. 2—representing said information in the SQL databases and tables—schematically represented by 3 in FIG. 1 and FIG. 2. Each of said relational SQL units comprise a plurality of related words and terms and related relational SQL keys—without redundant repeat and duplicate—in and among numerous SQL databases and tables infra. Said relational SQL keys—in millions in said SQL databases and tables are related to millions of medical and surgical words, terms, phrases, acronyms and synonyms use and being used by and among physicians and lay-people including patients and in the present invention henceforth words and terms representing chief complaints, signs and symptoms, reviews of systems, physical examinations or findings, laboratory results, anatomical locations or sidedness such as, but not limited to, left, right, unilateral, bilateral, both, contralateral, opposite, superior, rostral, upper, caudal, inferior, lower, superficial, deep, profound, etc., and anatomical sites, diagnoses, differential diagnoses, treatments and said individual physicians' identities and practices created, generated and submitted to and compiled in said SQL databases and tables in and manage by the SQL Server in a functioning and operating computer server or servers—schematically bound within two straight lines 1 in FIG. 1 and FIG. 2—by physicians and said individual physicians using computers, laptops, wireless, mobile communication equipment including smartphones possessing keyboards, application software and said viewing screens including touch-sensitive or touch screens enabled by Web browsers henceforth devices for accessing—schematically represented by a vertical bidirectional arrow [symbol] 2 in FIG. 1 and FIG. 2—said computer servers 1 in a network or networks of said devices and computer servers.

First, said relational SQL units 5 are created, generated, expanded and improved in SQL databases and tables comprising relational SQL keys 4 related to said words and terms representing signs and symptoms, reviews of systems, physical examinations or findings, laboratory results, anatomical locations, anatomical sites, diagnoses, differential diagnoses, treatments, assessments and plans, recommendations, advices, referrals and follow-ups in the SQL Server in said computer server or servers enabled by the innovative computer programs and software for communicating with and commanding and providing instructions for said SQL Server to create, generate and manage said the SQL databases and tables and relational SQL units coupled to said SQL Server, at least one computer scripting language and said computer server or servers by physicians including the present patent applicant—better understood here as physician authors of said basic SQL structure comprising said SQL databases and tables said SQL keys and relational SQL units—using said devices for accessing said SQL Servers by keyboarding said words and terms and/or retrieving said words and terms from the SQL databases and tables into interactive drop-down lists and menus on the viewing screens enabled by said computer scripting language, Java Script, AJAX and the innovative computer programs and software for communicating with and commanding and providing instructions for said SQL Server to create, generate and manage said the SQL databases and tables and relational SQL units and submitting said selected words and terms to said SQL Server.

Second, further to supra, the present invention must provide a system and method for further expanding and improving said SQL databases and tables comprising relational SQL keys related to said words and terms representing signs and symptoms, reviews of systems, physical examinations or findings, laboratory results, anatomical locations, anatomical sites, diagnoses, differential diagnoses, treatments and related individual physicians' identities and practices and specialties in said SQL Server enabled by the innovative computer programs and software for communicating with and commanding and providing instructions for said SQL Server to create, generate and manage said the SQL databases and tables and relational SQL units coupled to said SQL Server, at least one computer scripting language and said computer server or servers by said individual physicians—number in thousands to hundreds of thousands—of diverse and different medical and surgical specialties and practices in America and all over the world using said devices for accessing said SQL Servers by keyboarding said words and terms and/or retrieving said words and terms from the SQL databases and tables into interactive drop-down lists and menus on the viewing screens enabled by said computer scripting language, Java Script, AJAX and the innovative computer programs and software for communicating with and commanding and providing instructions for said SQL Server to create, generate and manage said the SQL databases and tables and relational SQL units and submitting said selected words and terms to said SQL Server.

As taught by said pending patent applications of the applicant of the present invention, there are at least four innovative methods and systems provided by said pending applications which are applied as one of the preferred embodiments of the innovative present invention enabling any and all individual physicians and doctors—tens to hundreds of thousands of physicians and doctors in America and the world—from any and all medical and surgical specialties—in the course of or related to the caring and documenting diagnoses and related health, health-care and health-care services of and for patients and participating in the health and health-care endeavors created and effected by said pending patent applications and UnitedPhysicians.com—to repetitively generate electronic information and data comprising words, terms, phrases, acronyms and synonyms on and related to and representing individual diagnoses and related chief complaints, signs and symptoms, diagnoses, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals, recommendations and physicians' locations, specialties and practices by said individual physicians using computers, laptops, wireless, mobile communication equipment including smartphones possessing keyboards, application software and said viewing screens including touch-sensitive or touch screens enabled by Web browsers henceforth devices for accessing said SQL Servers and keyboarding said words and terms and/or retrieving said words and terms from said SQL databases and tables in said SQL Server into interactive drop-down lists and menus on the viewing screens enabled by said computer scripting language, Java Script, AJAX and the innovative computer programs and software for communicating with and commanding and providing instructions for said SQL Server to create, generate and manage said the SQL databases and tables and relational SQL units and submitting said individual physicians' generations to said computer server or servers using said devices and the Internet.

Said individual physicians' accesses to and interactions with said computer server or servers and queries and submissions and view and uses—schematically represented by said vertical bidirectional arrow [symbol] 2 in FIGS. 1 and 2—as described infra are enabled by a plurality of first individual interactive and adaptable related electronic templates as taught in said pending patent applications. In addition, briefly herein although detailed in said pending patent applications, said information and data including words and terms on or relating to health care and health-care services are generated, submitted, stored, related, compiled or pooled in the database and/or databases in and manage by said SQL server and are retrieved—using computer mice, keyboards, physicians' or patients' fingers on the touch-enabled viewing screens and/or voice-activation and the like—by and displayed to physicians and patients as numerous interactive pop-up and/or drop-down lists and/or menus of words, terms, phrases, sentences, texts, synonyms, acronyms, texts, numbers, graphics, and word and term headers or headings comprising information and data on and relating to said DIAGNOSES on diseases, disorders, health, health-care and health-care services use by physicians of about 85 medical and surgical specialties and practices. Moreover, interactive graphics such as, but not limited to, U.S. Pat. No. 6,132,218 which can be clicked to present pop-up and/or drop-down lists and/or menus of words, terms, phrases, sentences, texts, synonyms, acronyms, texts, numbers, graphics, and word and term headers or headings comprising information and data on and relating to said DIAGNOSES on diseases, disorders, health, health-care and health-care services use by physicians of about 85 medical and surgical specialties and practices viewable and useable by said physicians and/or patients. Furthermore, in the preferred embodiments of said patent applications and the present invention, said word and term headers comprise Diagnosis, Evaluation, Chief Complaint, Review of Systems, Physical Examination, Infectious Diseases, Differential Diagnosis, Laboratories such as, but not limited to, Imaging, Body Fluid Tests and Tissues Examination, Assessment and Plan, Medications, Treatment, Surgery, Recommendations, Guidelines, Referral and Follow-up wherein said information and data including said words and terms are found and/or related.

The present invention provides a process for retrieving and displaying on said viewing screens and enabling the uses, edits, updates, improvements, expansions and inspections of said individual compilations and pools of said relations of individual diagnoses, individual syndromes and diagnoses or syndromes in individual groups of diagnoses or syndromes and related diseases, disorders, differential diagnoses and chief complaints, symptoms and signs, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and practices by physicians using said devices and the Internet to access said computer server, servers, virtual server and/or virtual servers in said network or networks of computer servers and devices effected in and by said computer server or servers and effected by said Windows Server, SQL Server, Web server, Visual Studio and .Net, computer scripting languages, Java script, AJAX, HTML, XHTML and said innovative computer programs and software operating in said computer server or servers and at least a Web browser in said devices in said network or networks of computer servers and devices.

In said SQL Server, enabled by the Stored Procedures of said SQL Server, to transform said information and data into SQL-created and SQL-generated relational SQL databases and tables—schematically represented by 3 in FIG. 1 and FIG. 2—wherein further compilations, relations and pooling of hundreds of thousands—millions of individual SQL keys representing said individual words and terms by said SQL Server are effected by said innovative computer programs and software for communicating with and commanding and providing instructions for said SQL Server to create, generate and manage said relational SQL keys in said SQL databases and tables from the relations of said words and terms submitted by said physicians.

Further to supra, the present invention provides said process for creating, generating and maintaining said relational SQL units 5 comprising said individual relational SQL keys 4 without redundant repeats and duplicates of SQL keys in said relational SQL units 5. The present invention provides a process for said operating computer server or servers commanded by said unique and innovative computer programs and software for commanding and communicating with said SQL Server and said relational SQL databases and tables and coupling with said computer scripting language for creating, compiling, pooling and relating relational data in said SQL databases and tables and for repetitively scanning and checking for redundant duplicates or repeats, doubles in individual physicians' submissions related to individual diagnoses or individual syndromes or diagnoses in individual groups of diagnoses and related relational data in said SQL databases and tables, for removing said redundant duplicates or repeats, doubles from relational data from said SQL database and/or databases or for not inserting said redundant duplicates or repeats, doubles into said relational data in said SQL databases and for compiling, pooling and relating relational data in said SQL databases, for repetitively creating, generating, managing, relating, improving said relational data, for generating, improving, updating and inserting additional data into said compiled, related and pooled relational SQL keys in said SQL databases and tables and for generating and displaying said relational SQL units 5 of the present invention.

Said SQL keys 4 are such as, but not limited to, primary keys, foreign keys and surrogate keys representing said words and terms representing individual diagnoses, individual syndromes, chief complaints, signs and symptoms, diagnoses, differential diagnoses, reviews of systems, physical examinations, laboratories, imaging, body fluid tests and tissues examinations, laboratory results, anatomical organ systems, anatomical locations and anatomical sites and parts of human, family histories, physiology, genetics, immunizations, treatments, surgeries, procedures, medications, drugs and therapeutics and effects and side-effects on human organs and bodies of said medications, drugs and therapeutics, guidelines, protocols, referrals, recommendations and physicians' identities, specialties and practices in about 85 medical and surgical specialties and practices in said SQL databases and tables. Said compilations, relations and pools of said SQL keys enabled and effected by said innovative computer programs and software are created and generated to compilations, relations and pools of SQL keys on said words and terms in said about 85 medical and surgical specialties and practices in said SQL databases and tables.

Third, further to supra, the present invention provides the creations, generations, managements and expansions of said SQL databases and tables comprising at least one signs and symptoms table, a plurality of causes, provocatives, palliatives, severity of signs and symptoms and temporal factors of said signs and symptoms tables, a plurality of reviews of systems tables, a plurality of physical examinations or findings tables, at least one laboratory results table, at least one anatomical locations table, a plurality of anatomical sites tables, a plurality of diagnoses tables, a plurality of differential diagnoses tables, a plurality of treatments tables, a plurality of synonyms and acronyms of said words and terms; a plurality of individual physicians and physicians' identities, practices and specialties tables in and manage by said SQL Server. However, the number of said SQL databases and tables for each said category or heading may vary from supra with needs of the present invention to fulfill its goals and objectives.

Fourth, further to supra, the present invention provides said innovative computer programs and software for communicating with and commanding and providing instructions for said SQL Server to create, generate, manage and maintain thousands—millions of said relational SQL units 5 comprising said individual thousands—millions of said relational SQL keys 4 without redundant repeats and duplicates of said SQL keys 4 in said relational SQL units 5 from and among said SQL databases and tables. The present invention provides a process for said operating computer server or servers commanded by said unique and innovative computer programs and software for commanding and communicating with said SQL Server and said relational databases and tables and coupling with said computer scripting language for creating, compiling, pooling and relating relational data in said SQL databases and tables and for repetitively scanning and checking for redundant duplicates or repeats, doubles in individual physicians' submissions related to individual diagnoses or individual syndromes or diagnoses in individual groups of diagnoses and related relational data in said SQL databases and tables, for removing said redundant duplicates or repeats, doubles from relational data from said SQL database and/or databases or for not inserting said redundant duplicates or repeats, doubles into said relational data in said SQL databases and for compiling, pooling and relating relational data in said SQL databases, for repetitively creating, generating, managing, relating, improving said relational data, for generating, improving, updating and inserting additional data into said compiled, related and pooled relational SQL keys in said SQL databases and tables and for generating and displaying said relational SQL units 5 of the present invention.

In other words, said relational SQL units 5 comprising said SQL Keys 4 without redundant repeats and duplicates of SQL keys in said relational SQL units upon retrieved from the SQL databases and tables 3 in said SQL Server into interactive drop-down lists and menus on the viewing screens and human figurines and images on said viewing screens and viewed and used—clicking and selecting—by said physicians and people. Said relational SQL units 5 comprising said individual relational SQL keys 4 without redundant repeats and duplicates of SQL keys in said relational SQL units are used and applied in the computer server-executed algorithms for scanning and matching of said words and terms in said relational SQL units with words and terms in queries comprising symptoms signs, reviews of systems (ROS), physical examinations (PE), laboratory report (LR), anatomical positions (AP) and anatomical sites (AS)—schematically represented by 8 in FIG. 1 and FIG. 2—submitted—schematically represented by a vertical bidirectional arrow [symbol] 7 in FIG. 1 and FIG. 2—by said individuals or individual groups of people to said SQL Server in said computer server or servers 1.

Said thousands—millions of relational SQL units 5 comprising said thousands—millions of relational SQL keys related to said words and terms representing related chief complaints, signs and symptoms, reviews of systems, physical examinations or findings, laboratory results, anatomical locations, anatomical sites, diagnoses, differential diagnoses, treatments and individual physicians' identities, specialties and practices in said SQL databases and tables 3. As a schematic example—schematically represented by 6 in FIG. 1 and FIG. 2—of thousands—millions of said relational SQL units comprising relational SQL keys in said SQL databases and tables 3 comprising at least one signs and symptoms table, and related plurality of causes, provocatives, palliatives, severity of signs and symptoms and temporal factors of said signs and symptoms tables (not shown), plurality of reviews of systems tables, plurality of physical examinations or findings tables, at least one laboratory results table, at least one anatomical locations table, a plurality of anatomical sites tables, a plurality of diagnoses tables, a plurality of differential diagnoses tables, a plurality of treatments tables, a plurality of synonyms and acronyms of said words and terms and a plurality of individual physicians and physicians' identities, practices and specialties tables. However, the number of said SQL databases and tables for each said category or heading may vary from supra with needs of the present invention to fulfill and achieve its goals and objectives.

The peoples' accesses to and interactions with said computer server or servers and generations and submissions of queries 8 and views and uses—schematically represented by said vertical bidirectional arrow [symbol] 7 in FIGS. 1 and 2—of the present invention as described infra are enabled by a plurality of individual interactive and adaptable related electronic templates as taught in said pending patent applications and the methods and system of the present invention described infra.

The present invention provides the computer server-executable algorithms for scanning and matching queries—schematically represented by 8 in FIG. 1 and FIG. 2—comprising chief complaints or symptoms signs, reviews of systems (ROS), physical examinations (PE), laboratory report (LR), anatomical positions (AP) and anatomical sites (AS) submitted—schematically represented by a vertical bidirectional arrow [symbol] 7 in FIG. 1 and FIG. 2—by said individuals or individual groups of people to said SQL Server in said computer server or servers 1 for computer server-automatic deducing said information on individual information on individual physicians' identities and practices and individual diagnoses and related treatments. Said individual queries 8 submitted to said computer server or servers by said individuals or individual groups of people keyboarding said words and terms representing signs and symptoms, reviews of systems, physical examinations or findings, laboratory results, anatomical locations and anatomical sites and/or retrieving said words and terms from said SQL databases and tables into interactive drop-down lists and menus on said viewing screens enabled by said computer scripting language, Java Script, AJAX and said innovative computer programs and software for communicating with and commanding and providing instructions for said SQL Server to create, generate and manage said the SQL databases and tables and relational SQL units and selecting by clicking or touching interactive said words and terms on said viewing screens and submitting said selected words and terms to said SQL Server and said memories of said computer server or servers using said devices to access said computer servers.

The number of relational SQL units comprising SQL keys from said SQL databases and tables to be used and applied for each query 8 is a function of the number of words and terms in said query 8 comprising symptoms signs, reviews of systems (ROS), physical examinations (PE), laboratory report (LR), anatomical positions (AP) and anatomical sites (AS) submitted to said computer server or servers by said person or group of persons.

The present invention provides the computer server-executable algorithms—one of which is schematically represented by 6 comprising relational SQL units 5 computer server-automatically composed from said relational SQL keys 4 in and among at least one signs and symptoms table, related plurality of causes, provocatives, palliatives, severity of signs and symptoms and temporal factors of said signs and symptoms tables (not shown), plurality of reviews of systems tables, plurality of physical examinations or findings tables, at least one laboratory results table, at least one anatomical locations table, a plurality of anatomical sites tables, a plurality of diagnoses tables (FIG. 2), a plurality of differential diagnoses tables (not shown), a plurality of treatments tables (not shown), a plurality of synonyms and acronyms of said words and terms (not shown) and a plurality of individual physicians and physicians' identities, practices and specialties tables, and other categories (not shown) of SQL databases and tables whenever and wherever applicable to achieve the goals and objectives of the present invention for computer server-deducing for computer server-automatic deducing said information on individual information on individual physicians' identities and practices—FIG. 1—and individual diagnoses—FIG. 2 and related treatments and differential diagnoses from said SQL databases and tables enabled by said innovative computer programs and software for processing the relations of said relational SQL units 5 and said individual queries 8 of individual or individual groups of people enabled by said innovative computer programs and software for communicating with, commanding and providing computer server-executable algorithms for said computer server or servers possessing memories and operating said innovative computer programs and software coupled to at least one computer scripting language and a SQL Server for computer server-automatically deducing and displaying the outcomes of said scans and matches from said individual queries 8 and said relational SQL units 5 comprising SQL keys 4. Although one of said algorithms 6 is shown, there are at least ten algorithms, permutations or orders for scanning and matching of said individual queries 8 and said relational SQL units 5 comprising SQL keys 4 provided by the present invention which can reprogram the codes in said innovative computer programs and software for communicating with, commanding and providing computer server-executable algorithms for said computer server or servers.

In FIG. 1 and FIG. 2, said innovative computer programs and software instruct said computer server or servers to automatically sequential scanning and matching—schematically represented by 9 in FIG. 1 and FIG. 2—said individual queries 8 comprising words and terms representing comprising chief complaints or symptoms signs, reviews of systems (ROS), physical examinations (PE), laboratory report (LR), anatomical positions (AP) and anatomical sites (AS) submitted—schematically represented by [symbol] 7 in FIG. 1 and FIG. 2—by said individuals or individual groups of people to said SQL Server in said computer server or servers 1 with or against thousands—millions of said relational SQL units 5 comprising relational SQL keys 4 in said SQL databases and tables 3 derived supra comprising at least one signs and symptoms table and related plurality of causes, provocatives, palliatives, severity of signs and symptoms and temporal factors of said signs and symptoms tables (not shown), plurality of reviews of systems tables, plurality of physical examinations or findings tables, at least one laboratory results table, at least one anatomical locations table, a plurality of anatomical sites tables, a plurality of diagnoses tables, a plurality of differential diagnoses tables, a plurality of treatments tables, a plurality of synonyms and acronyms of said words and terms and a plurality of individual physicians and physicians' identities, practices and specialties tables and other categories of tables whenever and wherever applicable to achieve the goals and objectives of the present invention.

Therefore, using a simple and schematic representative algorithm 6 in FIG. 1 and FIG. 2 as an example for computer server-automatic deducing said information, a simple and schematic representative query 8 comprising words and terms representing comprising chief complaints or symptoms signs, reviews of systems (ROS), physical examinations (PE), laboratory report (LR), anatomical positions (AP) and anatomical sites (AS) submitted—schematically represented by [symbol] 7 in FIG. 1 and FIG. 2—by a person or an individual group of people to said SQL Server in said computer server or servers. Said submitted query 8 is scanned and matched 9 with or against computer server-selected relational SQL units 6 from said thousands—millions of said relational SQL units 5 comprising relational SQL keys 4 in said SQL databases and tables 3.

Said computer server-selected relational SQL units 6 being used to explain the preferred embodiments of the present invention—are computer server-automatically determined by said computer server or servers enabled by said innovative computer programs and software for processing the sequences of words and terms in said sample query 8 with or against said computer server-recognized and selected relational words and terms in pertinent or relevant relational SQL units 6 in and among thousands—millions of said relational SQL units 5 comprising relational SQL keys 4 in said SQL databases and tables 3.

To achieve supra, FIG. 1 and Fig. are used to explain the unlimited or limitless processing of said computer server-deducing said information enabled by said computer server-executable algorithms provided by the innovative computer programs and software. One of the preferred embodiments of the present invention is illustrated by one of said computer server-executable algorithms in FIG. 1 and FIG. 2 where horizontal unidirectional arrows → and ← representing said instructions or codes for algorithm or order for scanning and matching of said words and terms in said query 8 and words and terms relational SQL units 5. The process for a representative computer server-executing algorithm for processing said relations of words and terms in said relational SQL units 5 and words and terms in said query 8 comprises, first process, a process for computer server-automatically and sequentially scanning and matching said words and terms representing Symptoms Signs—and related causes, provocatives, palliatives, severity of signs and symptoms and temporal factors of said signs and symptoms (not shown)—and anatomical locations (AP) and anatomical sites (AS) in said query 8 of individuals or individual groups of people with same, similar, equivalent or synonymous words and terms representing signs and symptoms, causes, causes, provocatives, palliatives, severity of signs and symptoms and temporal factors of said signs and symptoms, anatomical locations and anatomical sites and related to individual SQL keys and related first individual groups of individual SQL keys representing words and terms representing first information on individual physicians' identities and practices and specialties in said individual physicians and physicians' identities, practices and specialties tables (MD Table I) in said individual relational SQL units in said individual SQL units. Second process, computer server-automatically selecting matches of words and terms representing said Symptoms Signs, AP and AS in said query 8 with said words and terms representing said Symptoms Signs, AP and AS in said individual relational SQL units 5 and related to first individual SQL keys and words and terms representing a first information on individual physicians' identities and practices and specialties in said individual relational SQL units to be a first individual groups of words and terms and individual SQL keys representing said first information on individual physicians' identities and practices and specialties in said individual physicians and physicians' identities, practices and specialties tables (MD Table I). Third process, computer server-automatically storing selections of said first individual groups of words and terms and said related individual SQL keys in said memories of said computer server or servers and said SQL databases and tables in said SQL Server (Memories 10).

Fourth process, computer server-automatically and first sequentially scanning and matching said first individual groups of words and terms in said memories of said computer server or servers and said SQL databases and tables in said SQL Server (Memories 10) with second words and terms representing a second information on individual physicians' identities and practices and specialties in said relational SQL units comprising said second words and terms representing said second information on individual physicians' identities and practices and specialties in said individual physicians' identities and practices and specialties tables (MD Table II) related to reviews of systems, anatomical locations, anatomical sites in said relational SQL units and related to anatomical sites tables (AS Table II) and anatomical locations (not shown) and reviews of systems tables (ROS Tables) and second sequentially scanning and matching first words and terms in said individual relational SQL units representing anatomical sites, reviews of systems and anatomical locations with second words and terms representing reviews of systems (ROS), anatomical locations (AP) and anatomical sites (AS) in said query 8. Fifth process, computer server-automatically selecting said matches of said first individual groups of words and terms and said second words and terms representing information on individual physicians' identities and practices and specialties (MD Table II) represented by SQL keys in said relational SQL units related to said matches of said first and second words and terms representing reviews of systems, anatomical locations and anatomical sites. Sixth process, computer server-automatically storing said matches of said first individual group of words and terms and said second individual group of words and terms representing information on individual physicians' identities and practices and specialties represented by SQL keys in said relational SQL units related to said matches of said first and second words and terms representing reviews of systems, anatomical locations and anatomical sites comprising a third individual group of words and terms and third group of individual SQL keys representing third information on individual physicians' identities and practices and specialties in said relational SQL units in said SQL databases and tables in said SQL Server and memories of said computer server or servers (Memories 11).

Seventh process, computer server-automatically and first sequentially scanning and matching said third individual groups of words and terms with fourth words and terms representing a fourth information on individual physicians' identities and practices and specialties in said relational SQL units comprising said fourth words and terms representing said fourth information on individual physicians' identities and practices and specialties in said individual physicians' identities and practices and specialties tables related to anatomical sites, physical examinations or findings and anatomical locations in said relational SQL units and in related physical examinations or findings, anatomical locations, anatomical sites tables and second sequentially scanning and matching first words and terms in said individual relational SQL units representing anatomical sites, physical examinations or findings and anatomical locations with second words and terms representing anatomical sites (AS), physical examinations or findings (PE) and anatomical locations (AP) in said query 8 of individuals or individual groups of people. Eighth process, computer server-automatically selecting said matches of said third individual groups of words and terms and said fourth individual groups of words and terms representing information on individual physicians' identities and practices and specialties represented by SQL keys in said relational SQL units related to said matches of said first and second words and terms representing physical examinations or findings, anatomical locations and anatomical sites. Ninth process, computer server-automatically storing said matches of said fourth individual group of words and terms representing information on individual physicians' identities and practices and specialties represented by SQL keys in said relational SQL units related to said matches of said first and second words and terms representing physical examinations or findings, anatomical locations and anatomical sites comprising a fourth individual group of words and terms and fourth group of individual SQL keys representing fourth information on individual physicians' identities and practices and specialties in said relational SQL units in said SQL databases and tables in said SQL Server and memories of said computer server or servers (Memories 12)

Tenth process, computer server-automatically and first sequentially scanning and matching said fourth individual groups of words and terms with fifth words and terms representing a fifth information on individual physicians' identities and practices and specialties in said relational SQL units comprising said fifth words and terms representing said fifth information on individual physicians' identities and practices and specialties in said individual physicians' identities and practices and specialties tables related to anatomical sites or organ systems, laboratory results and anatomical locations in said relational SQL units and in related laboratory results, anatomical locations, anatomical sites and organ systems tables and second sequentially scanning and matching first words and terms in said individual relational SQL units representing anatomical sites or organ systems, laboratory results and anatomical locations with second words and terms representing anatomical sites or organ systems, laboratory results and anatomical locations in said individual queries of individuals or individual groups of people. Eleventh process, computer server-automatically selecting said matches of said fourth individual groups of words and terms and said fifth individual groups of words and terms representing information on individual physicians' identities and practices and specialties represented by SQL keys in said relational SQL units related to said matches of said first and second words and terms representing anatomical sites or organ systems, laboratory results and anatomical locations. Twelfth process, computer server-automatically storing said matches of said fourth individual group of words and terms and said fifth individual group of words and terms representing information on individual physicians' identities and practices and specialties represented by SQL keys in said relational SQL units related to said matches of said first and second words and terms representing physical examinations or findings, anatomical locations and anatomical sites comprising a fifth individual group of words and terms and fifth group of individual SQL keys representing fifth information on individual physicians' identities and practices and specialties in said relational SQL units and represented by SQL keys in said SQL databases and tables—schematically represented by 14 in FIG. 1 and FIG. 2 in and manage by said SQL Server.

In said first to twelfth processes in FIG. 1—a deductive or elimination process a complex and intelligent computer-biological electronic-neural system—it is to be understood that the number of physicians in physicians in Memories, SQL Databases and Tables 13—who are being found by said query 1 in and from said relational SQL units by an individual or a group of individual—may but, preferably, will be less than number of physician in Memories 10.

In said first to twelfth processes in FIG. 2—a deductive or elimination process in a complex and intelligent computer-biological electronic-neural system—it is to be understood that the diagnosis or the number of diagnoses in Memories, SQL Databases and Tables 13—which is or are being found by said query 1 in and from said relational SQL units by an individual or a group of individual—preferably, will be one diagnosis although, in less perfect instances, a few diagnoses which can be narrowed further by applying as many categories supra to one diagnosis as taught by the present invention.

To achieve the goals and objectives of the present invention by said individuals and said individual groups of people, the present invention further provides a process for computer server-repetitively and sequentially scanning and matching said individuals' and said individual groups of people's any and all queries comprising new, more, edited and versions of words and terms in their attempts to obtain and know the accurate and desired diagnosis per attempt and precise or more precise or most precise related information on individual physicians' identities and practices and specialties.

Further to supra, the present invention also provides said individuals and said individual groups of people with individual reports of said individual queries and words and terms in said scans, matches and selections and the outcomes and results of said processes which are viewable on said viewing screens by said people including physicians.

Said representative algorithm provided by the present invention is used and applied to computer server-deducing and displaying on the viewing screens information on individual diagnoses in FIG. 2. In these instances in said computer server or servers, related words and terms representing treatments and differential diagnoses and related SQL keys in said SQL databases and tables related to said individual diagnoses are retrieved and displayed on said viewing screens.

Said information on individual physicians' identities and practices and specialties and individual diagnoses and related treatments and differential diagnoses are retrieved—schematically represented by a vertical bidirectional arrow [symbol] 15 in FIG. 1 and FIG. 2 and displayed on said viewing screens of said devices 16 enabled by the Web browsers being used by said people in said network or networks of said computer servers and devices. As taught by and further to U.S. Pat. No. 6,132,218 entitled Images for communication of medical information in computer granted Oct. 17, 2000 said information can also be computer server-automatically displaying as 2-dimensional and 3-dimensional arrays of information on one-multiple anatomical sites or organ systems on one-multiple interactive 2-dimensional and 3-dimensional human figurines, bodies and images enabled by said computer scripting language, Java Script, AJAX and said innovative computer programs and software and various other commercially available video and computer programs and software for affecting the perceptions and motions of said information on and related to said 3-dimensional human figurines, bodies and images and their derivatives.

In summary, the present invention provides an adaptable computer server-intelligent system and method for computer server-deducing and displaying on the viewing screens precise information on individual physicians' identities and practices and specialties and individual diagnoses and related treatments and differential diagnoses represented by individual SQL keys in relational SQL units comprising relational SQL keys in the SQL databases and tables in responding to individual queries for said information from individuals or individual groups of people using computers, laptops, wireless, mobile communication equipment including smartphones possessing keyboards, application software and said viewing screens including touch-sensitive or touch screens enabled by Web browsers for accessing said computer servers in a network or networks of said devices and computer servers for eliminating the random, tedious and time-consuming and costly processes for searching for and referring to physicians and coordinating health and health-care services among said physicians and people and optimizing health, preventive health-care, continuity of health-care, managing chronic diseases and health-care of people and, furthermore, the outcomes of the present invention are a system and method for solving said problems and dilemmas comprising interactive and adaptable pooled consensuses, guidelines and protocols for managing and delivering better and optimal qualities, quantities, managements and deliveries of health, health-care and health-care services for physicians by said network or networks of computer server, computer servers or virtual server or servers and devices.

It is to be understood that the present invention also provides said system and method and said algorithms as represented by said one algorithms—applicable to the remaining categories and combinations of said categories of family histories, genetics, immunizations, treatments, surgeries, procedures, medications, drugs and therapeutics and effects and side-effects on human organs and bodies of said medications, drugs and therapeutics, assessments and plans, guidelines, protocols, referrals, recommendations by the relational SQL unites and SQL keys for eliminating the random, tedious and time-consuming and costly processes for searching for and referring to physicians and coordinating health and health-care services among said physicians and people and optimizing health, preventive health-care, continuity of health-care, managing chronic diseases and health-care of people.

Although said one representative and simple algorithm is used to represent one of the preferred embodiments of the present invention providing and system and method for computer server-automatically deducing information on individual physicians' identities and practices and specialties, individual diagnoses and related differential diagnoses and treatments, it will be appreciated by those skilled in the art and medicine that more complex and extensive algorithms and adaptations, variations, and derivatives are and will be made and achieved without departing from the spirit and the scope of the claims of the present invention.

It is factually reasonable and accurate to claim that at least one of the preferred embodiments of the present invention epitomizes and represents a truly first globally vast, complex and most intelligent computer-biological electronic-neural system and method comprising computer servers, virtual servers and devices in a network or networks of computer servers, virtual servers, devices and thousands to hundreds of thousands of physicians and billions of people using said network or networks of computer servers and virtual servers and devices possessing and operating improvable innovative computer programs, software and adaptable, improvable, expandable, immensely compiled, related and pooled relational information and data on medicine, health, health-care and health-care services for managing the optimal or the best qualities, quantities and deliveries of health, health-care and health-care services by physicians for billions of people. Further fact, the preferred embodiments of the present invention, in many settings and circumstances, exceed the performances and outputs of the memory, reasoning, deductive, analytical and logical capabilities of physicians' brains.

The present invention provides operating and functioning said computer servers possessing and operating memories, processors, at least a server operating system, a Windows Server, a SQL Server and computer scripting languages coupled to the innovative computer programs and software infra, a Visual Studio and .Net, Java script, AJAX, HTML, XHTML, a Microsoft IIS, Apache, a Web browser, Web server and possessing and operating the present applicant's invented innovative computer programs and software for commanding and communicating for commanding and communicating with said SQL Server and said relational database and/or databases and coupling with said computer scripting languages and said innovative computer programs and software for creating and generating a plurality of individual interactive and adaptable related electronic templates, a plurality of interactive pop-up and/or drop-down lists and/or menus of words, terms, phrases, sentences, texts, synonyms, acronyms, texts, numbers, graphics, and word and term headers or headings comprising information and data on and relating to said diagnoses on diseases, disorders, health, health-care and health-care services in categories of chief complaints, signs and symptoms, reviews of systems, physical examinations or findings, laboratory results, anatomical locations, anatomical sites and organ systems, diagnoses, differential diagnoses, treatments, assessments and plans, recommendations, advices, referrals and follow-ups henceforth information and data use by physicians of about 85 medical and surgical specialties and practices, for creating, generating, expanding and improving SQL databases and tables comprising relational SQL keys related to said words and terms representing said in said SQL databases and tables in said SQL Server, for creating, compiling, pooling and relating relational information and data in said SQL databases and tables and relational SQL units, for repetitively scanning and checking for redundant duplicates or repeats, doubles in individual physicians' submissions related to individual diagnoses or individual syndromes or diagnoses in individual groups of diagnoses and related relational information and data in said SQL databases and tables, for removing said redundant duplicates or repeats, doubles from relational information and data from said SQL databases, tables and said relational SQL units and for not inserting said redundant duplicates or repeats, doubles into said relational information and data in said SQL databases and tables and relational SQL units, for creating, generating and maintaining said relational SQL units comprising relational SQL keys in said SQL databases and tables comprising plurality of said information and data tables, for creating, generating and maintaining individual unique relational SQL units comprising said relational SQL keys, for creating, generating and maintaining said unique relational SQL units comprising said relational SQL keys without redundant repeats and duplicates of SQL keys in said relational SQL units, for generating queries for said information on individual information on individual physicians' identities and practices and individual diagnoses and related treatments and differential diagnoses by people, for enabling said computer server or servers to process the relations of said words and terms and said relational SQL units and words and terms in said queries in said SQL Server and in said memories of said computer server or servers, for providing and instructing computer server or servers to execute algorithms for processing said relations of said words and terms and said relational SQL units and words and terms in said queries in said SQL Server and in said memories of said computer server or servers, for providing and instructing computer server or servers to sequentially scan and match said words and terms and said relational SQL units and words and terms in said queries, for providing and instructing computer server or servers to sequentially select said information on individual physicians' identities and practices and specialties individual diagnoses and related treatments and differential diagnoses on viewing screens and for providing and enabling said computer server or server to display said information on individual physicians' identities and practices and specialties individual diagnoses and related treatments and differential diagnoses on viewing screens.

The present invention provides the innovative computer programs and software infra invented by the present patent applicant which were filed with and are stored in the Library of Congress in Washington, D.C. The present invention uses also the commercially available computer software (plural), programs and computer languages such as, but not limited to, those made and sold by Microsoft Corporation such as, but not limited to, Microsoft Windows Server operating system, Chrome operating system, Linux, SQL servers such as, but not limited to Microsoft SQL Server, MySQL and the like, Internet Explorer, various other Web browsers such as, but not limited to Firefox browser by Mozilla Foundation, Chrome Web browser, Safari, Opera and derivatives, Web server, Apache, Microsoft IIS, Visual Studio and .Net, Microsoft software including Notepad, Wordpad and .txt programs and their derivatives and the like and related and their database, databases and derivatives, other computer corporations' and companies' programs, languages, codes and databases and their derivatives which are commonly and routinely used by computer engineers and programmers such as, but not limited to, PHP, PERL, C languages, such as, but not limited to, C, C+, C++, C#, JAVA, Java Script, AJAX, HTML, XHTML and the like and related and their derivatives. Other computer programs and software also include application software (plural) also known as Applications or Apps for manipulating, texting, numbering, graphics, or any combinations of these elements for uses and applications with iPhone and iPad of Apple, Inc. and Google's Android software. Other security software are such as, but not limited to, encryption-decryption of the information and data infra and their derivatives and products, processes and software, Firewall, anti-viral and related, Secure Sockets Layer (SSL) or Transport Layer Security (TLS) and related and the like and their derivatives.

The standard commercial hardware and equipment being used in the TCP/IP networks and the like or equivalence such as, but not limited to, the Internet commerce are implemented and deployed per standard industrial practices and use hardware and equipment such as, but not limited to, computer servers and computers such as numerous HP and IBM servers, HP and Dell computers, Cisco routers and related, and various equipment including modems sold, lease, own and operate by cable companies such as, but not limited to, Time Warner and Optimum Online in New York, etc. Currently, HP ProLiant ML350 and ML110 Generation 4p Servers—see www.hp.com for details of the server hardware and internal design—and similar Dell server—see www.dell.com for details of the server hardware and internal design—used by the present patent applicant as the hardware wherein the computer programs and software(s) mentioned herein operate. It is obvious and known that with more extensive operations, requirements and equipment, server blades and various hardware and equipment configurations, virtual servers such as those sold by VMware, HP and IBM, and their derivatives being used by many large American corporations can and will be used to implement the present invention. Said programs and software enabled individuals and individual groups of people to use and apply the present invention.

Said preferred embodiments of the present invention are applicable to and used by individual physicians, individual patients, individual groups of physicians and individual groups of physicians and individual patients in same and diverse and different settings and locations. In other words, the preferred embodiments of the present invention are also enabled by popular commercial technologies provided www.webex.com by Cisco Systems, Inc. and www2.gotomeeting.com by Citrix Online, L.L.C. and the like provided by other companies or corporations for enabling individual persons in various and different settings and locations to conference or use said embodiments as individual groups of people being in said diverse or different settings and locations using said network or networks and the Internet to achieve the goals and objectives of the present invention. Said programs and software and the derivatives and the like enabled individuals and individual groups of people to use and apply the present invention.

Although sequences of applications of individual interactive words and terms representing diagnoses, syndromes and diagnoses or syndromes in individual groups of diagnoses or syndromes and compiled, related or pooled relational information and data on and related to diagnoses, syndromes and diagnoses or syndromes in individual groups of diagnoses or syndromes and related chief complaints, symptoms and signs, differential diagnoses, reviews of systems, physical examinations, family histories, genetics, immunizations, laboratories, imaging, body fluid tests and tissues examinations, assessments and plans, medications, treatments, procedures, surgeries, recommendations, guidelines, referrals, follow-ups, organs and anatomical sites and parts of humans and physicians' practices related to said diagnoses or said individual groups of diagnoses as one of the preferred embodiments of the present invention have been described, it is to be appreciated and understood by those skilled in the art that various combinations, permutations and orders of sequences of applications of said words, terms and phrases are some of the preferred embodiments of the present invention and are made, used and achieved without departing from the spirit and the scope of the claims of the present invention.

It is to be understood that a computer server, computer servers and/or virtual serves capable of computer-creating and -generating said consensuses, guidelines and protocols and computer-deducing information on individual physicians, practices and specialties and individual diagnoses, syndromes and diagnoses or syndromes in individual groups of diagnoses or syndromes and related treatments and related differential diagnoses of the present invention also embody any and all computers and mobile computers such as, but not limited to, and server blades and various hardware and equipment configurations, virtual servers such as those sold by VMware, HP and IBM, and their derivatives being used by many large American corporations can and will be used to implement the present invention. Furthermore, it is to be understood that computer or computers in the claims infra also implied computer server, computer servers, virtual server, virtual servers so that, for example, computer-created, computer-generated, computer-automatically and computational processes, etc., infra are synonymous with or embody computer server-created, computer server-generated and computer server-automatically, virtual server-created, virtual server-generated and virtual server-automatically, server-computational processes and virtual server-computational processes, etc.

Although one of the preferred embodiments of this invention encompassed individual compiled and pooled computer-created consensuses, guidelines and protocols comprising interactive and adaptable electronic templates comprising said relational information and data in said database and/or databases retrievable, viewable on the viewing screens of computers, portable and wireless electronic communication devices and interactive with and useable by physicians and patients in said network or networks of said computers, portable and wireless electronic communication devices and computer servers, it is understood that one of the preferred embodiments of the present invention also include the non-electronic versions of said consensuses, guidelines and protocols such as, but not limited to, verbal, speech, voice, sound, illustrated, graphic and printed versions and any combinations thereof of said consensuses, guidelines and protocols available, audible, viewable and useable by physicians and patients to achieve the objectives and goals of the present invention.

Although the preferred embodiments of this invention have been described for humans, it will be appreciated by those skilled in the art that adaptations and variations of the present invention may be made to apply to other species, animals, biological entities or structures, infectious particles or structures, and machines without departing from the spirit of the invention and the scope of the claims.

Although various preferred embodiments and representations of the present invention have been described, it will be appreciated by those skilled in the art that the real and practical implementations and their adaptations, variations and derivatives are and will be made and achieved without departing from the spirit and the scope of the claims of the present invention.

1. A system for computer server-deducing and displaying on the viewing screens information on individual physicians' identities and practices and specialties and individual diagnoses and related treatments and differential diagnoses represented by individual SQL keys in relational SQL units comprising relational SQL keys in the SQL databases and tables related to medical and surgical words, terms and phrases and synonyms and acronyms henceforth words and terms representing related signs and symptoms, reviews of systems, physical examinations or findings, laboratory results, anatomical locations, anatomical sites, diagnoses, differential diagnoses, treatments and said individual physicians' identities and practices created, generated and submitted to and compiled in said SQL databases and tables in and manage by the SQL Server in a functioning and operating computer server or servers possessing memories by said individual physicians using computers, laptops, wireless, mobile communication equipment including smartphones possessing keyboards, application software and said viewing screens including touch-sensitive or touch screens enabled by Web browsers henceforth devices for accessing said computer servers in a network or networks of said devices and computer servers for eliminating the random, tedious and time-consuming and costly processes for searching for and referring to physicians and coordinating health and health-care services among said physicians and people and optimizing health, preventive health-care, continuity of health-care, managing chronic diseases and health-care of people comprises:
said computer servers possessing and operating memories, processors, at least a server operating system, a Windows Server, a SQL Server, computer scripting language, the innovative computer programs and software coupled to said SQL Server and at least one of said computer scripting languages, a Visual Studio and .Net, Java script, AJAX, HTML, XHTML, a Microsoft IIS, Apache, a Web browser and Web server;
said innovative computer programs and software for creating and generating a plurality of individual interactive and adaptable related electronic templates, a plurality of interactive pop-up and/or drop-down lists and/or menus of words, terms, phrases, sentences, texts, synonyms, acronyms, texts, numbers, graphics, and word and term headers or headings comprising information and data on and relating to said diagnoses on diseases, disorders, health, health-care and health-care services in categories of chief complaints, signs and symptoms, reviews of systems, physical examinations or findings, laboratory results, anatomical locations, anatomical sites and organ systems, diagnoses, differential diagnoses, treatments, assessments and plans, recommendations, advices, referrals and follow-ups henceforth information and data use by physicians of about 85 medical and surgical specialties and practices, for creating, generating, expanding and improving SQL databases and tables comprising relational SQL keys related to said words and terms representing said in said SQL databases and tables in said SQL Server, for creating, compiling, pooling and relating relational information and data in said SQL databases and tables and relational SQL units, for repetitively scanning and checking for redundant duplicates or repeats, doubles in individual physicians' submissions related to individual diagnoses or individual syndromes or diagnoses in individual groups of diagnoses and related relational information and data in said SQL databases and tables, for removing said redundant duplicates or repeats, doubles from relational information and data from said SQL databases, tables and said relational SQL units and for not inserting said redundant duplicates or repeats, doubles into said relational information and data in said SQL databases and tables and relational SQL units, for creating, generating and maintaining said relational SQL units comprising relational SQL keys in said SQL databases and tables comprising plurality of said information and data tables, for creating, generating and maintaining individual unique relational SQL units comprising said relational SQL keys, for creating, generating and maintaining said unique relational SQL units comprising said relational SQL keys without redundant repeats and duplicates of SQL keys in said relational SQL units, for generating queries for said information on individual information on individual physicians' identities and practices and individual diagnoses and related treatments and differential diagnoses by people, for enabling said computer server or servers to process the relations of said words and terms and said relational SQL units and words and terms in said queries in said SQL Server and in said memories of said computer server or servers, for providing and instructing computer server or servers to execute algorithms for processing said relations of said words and terms and said relational SQL units and words and terms in said queries in said SQL Server and in said memories of said computer server or servers, for providing and instructing computer server or servers to sequentially scan and match said words and terms and said relational SQL units and words and terms in said queries, for providing and instructing computer server or servers to sequentially select said information on individual physicians' identities and practices and specialties individual diagnoses and related treatments and differential diagnoses on viewing screens and for providing and enabling said computer server or server to display said information on individual physicians' identities and practices and specialties individual diagnoses and related treatments and differential diagnoses on viewing screens;
said words and terms representing related signs and symptoms, reviews of systems, physical examinations or findings, laboratory results, anatomical locations, anatomical sites, diagnoses, differential diagnoses, treatments and said individual physicians' identities and practices created, generated and submitted to and compiled in said SQL databases and tables in and manage by the SQL Server;
said relational SQL units comprising relational SQL keys related to said words and terms in said SQL databases and tables;
individual unique relational SQL units comprising said words and terms and related relational SQL keys;
said individual unique relational SQL units comprising said relational SQL keys without redundant repeats and duplicates of SQL keys in said relational SQL units;
individuals or individual groups of people's queries comprising words and terms representing signs and symptoms, reviews of systems, physical examinations or findings, laboratory results, anatomical locations and anatomical sites keyboarded and/or retrieved from said SQL databases and tables into interactive drop-down lists and menus on said viewing screens enabled by said computer scripting language, Java Script, AJAX and said innovative computer programs and software for communicating with and commanding and providing instructions for said SQL Server and Java Script, AJAX to retrieve and display said interactive words and terms;
computer server-executable algorithms for processing the relations of words and terms in said relational SQL units and words and terms in said queries in said SQL Server and in said memories of said computer server or servers;
computer server-automated sequential scans and matches of words and terms in said queries with words and terms in said relational SQL units;
computer server-repetitive and sequential scans and matches of said words and terms and said relational SQL units and words and terms in said queries in said SQL Server and in said memories of said computer server or servers;
computer server-automated repetitive sequential scans and matches of words and terms in queries with words and terms in said relational SQL units;
computer server-automatic selections of said information on individual physicians' identities and practices and specialties represented by words and terms and related to SQL keys in said SQL databases and tables;
computer server-automatic selections of said information on individual diagnoses represented by words and terms and related to SQL keys in said SQL databases and tables;
computer server-automatic selections of said information on individual diagnoses and computer server-automatic generations of related treatments and differential diagnoses represented by words and terms and related to SQL keys in said SQL databases and tables;
computer server-automatic displays of said selections and generations on said viewing screens of said devices enabled by the Web browsers being used by said people; and
computer server-automatic displays of said selections and generations on the interactive 2-dimensional and 3-dimensional human figurines and images for displaying said selections on the anatomical sites of said figurines and images enabled by said computer scripting language, Java Script, AJAX and said innovative computer programs and software and Web browsers.

2. The system according to claim 1 wherein said SQL databases and tables comprise at least one signs and symptoms table, a plurality of causes, provocatives, palliatives, severity of signs and symptoms and temporal factors of said signs and symptoms tables, a plurality of reviews of systems tables, a plurality of physical examinations or findings tables, at least one laboratory results table, at least one anatomical locations table, a plurality of anatomical sites tables, a plurality of diagnoses tables, a plurality of differential diagnoses tables, a plurality of treatments tables, a plurality of synonyms and acronyms of said words and terms tables, a plurality of individual physicians and physicians' identities, practices and specialties tables in and manage by said SQL Server.

3. The system according to claim 1 wherein said individual relational SQL units comprise a plurality of relational SQL relations of SQL keys in:
a. said anatomical locations table, at least one of said anatomical sites tables, said signs and symptoms table and at least one of said individual physicians and physicians' identities, practices and specialties tables and at least one of said diagnoses tables;
b. said anatomical locations table, at least one of said anatomical sites tables, at least one of said reviews of systems tables and at least one of said individual physicians and physicians' identities, practices and specialties tables and at least one of said diagnoses tables;
c. said anatomical locations table, at least one of said anatomical sites tables, at least one of said physical examinations or findings tables and at least one of said individual physicians and physicians' identities, practices and specialties tables and at least one of said diagnoses tables;
d. said anatomical locations table, at least one of said anatomical sites tables, said laboratory results table and at least one of said individual physicians and physicians' identities, practices and specialties tables and at least one of said diagnoses tables;
e. said diagnoses tables and said treatments tables; and
f. said diagnoses tables and said differential diagnoses tables.

4. Each of said individual relational SQL units according to claim 3 comprises a plurality comprises at least two to several relational SQL keys in said tables.

5. The system according to claim 1 wherein said computer server-executable algorithms for processing the relations of said words and terms in said relational SQL units and words and terms in individual queries in said SQL Server and in said memories of said computer server or servers comprise:
a. computer server-automatic and sequential scans and matches of said words and terms representing signs and symptoms and causes, provocatives, palliatives, severity of signs and symptoms and temporal factors of said signs and symptoms, anatomical locations, anatomical sites in said individual queries of individuals or individual groups of people with same, similar, equivalent or synonymous words and terms representing signs and symptoms, causes, causes, provocatives, palliatives, severity of signs and symptoms and temporal factors of said signs and symptoms, anatomical locations and anatomical sites and related to individual SQL keys and related first individual groups of individual SQL keys representing words and terms representing first information on individual physicians' identities and practices and specialties in said individual physicians and physicians' identities, practices and specialties tables in said individual relational SQL units in said individual SQL units;
b. computer server-automatic selections of matches of said words and terms in said individual queries with said words and terms in said individual relational SQL units and related to first individual SQL keys and words and terms representing a first information on individual physicians' identities and practices and specialties in said individual relational SQL units to be a first individual groups of words and terms and individual SQL keys representing said first information on individual physicians' identities and practices and specialties in said individual physicians and physicians' identities, practices and specialties tables;
c. computer server-automatic stores of said selections of said first individual groups of words and terms and said related individual SQL keys in said memories of said computer server or servers and said SQL databases and tables in said SQL Server;
d. computer server-automatic first sequential scans and matches of said first individual groups of words and terms with second words and terms representing a second information on individual physicians' identities and practices and specialties in said relational SQL units comprising said second words and terms representing said second information on individual physicians' identities and practices and specialties in said individual physicians' identities and practices and specialties tables related to reviews of systems, anatomical locations, anatomical sites in said relational SQL units and in related reviews of systems, anatomical locations, anatomical sites tables and second sequential scans and matches of first words and terms in said individual relational SQL units representing anatomical sites, reviews of systems and anatomical locations with second words and terms representing reviews of systems, anatomical locations and anatomical sites in said individual queries of individuals or individual groups of people;
e. computer server-automatic selections of said matches of said first individual groups of words and terms and said second words and terms representing information on individual physicians' identities and practices and specialties represented by SQL keys in said relational SQL units related to said matches of said first and second words and terms representing reviews of systems, anatomical locations and anatomical sites;
f. computer server-automatic stores of said matches of said first individual group of words and terms and said second individual group of words and terms representing information on individual physicians' identities and practices and specialties represented by SQL keys in said relational SQL units related to said matches of said first and second words and terms representing reviews of systems, anatomical locations and anatomical sites comprising a third individual group of words and terms and third group of individual SQL keys representing third information on individual physicians' identities and practices and specialties in said relational SQL units in said SQL databases and tables in said SQL Server;
g. computer server-automatic first sequential scans and matches of said third individual groups of words and terms with fourth words and terms representing a fourth information on individual physicians' identities and practices and specialties in said relational SQL units comprising said fourth words and terms representing said fourth information on individual physicians' identities and practices and specialties in said individual physicians' identities and practices and specialties tables related to anatomical sites, physical examinations or findings and anatomical locations in said relational SQL units and in related physical examinations or findings, anatomical locations, anatomical sites tables and second sequential scans and matches of first words and terms in said individual relational SQL units representing anatomical sites, physical examinations or findings and anatomical locations with second words and terms representing anatomical sites, physical examinations or findings and anatomical locations in said individual queries of individuals or individual groups of people;
h. computer server-automatic selections of said matches of said third individual groups of words and terms and said fourth individual groups of words and terms representing information on individual physicians' identities and practices and specialties represented by SQL keys in said relational SQL units related to said matches of said first and second words and terms representing physical examinations or findings, anatomical locations and anatomical sites;
i. computer server-automatic stores of said matches of said third individual group of words and terms and said fourth individual group of words and terms representing information on individual physicians' identities and practices and specialties represented by SQL keys in said relational SQL units related to said matches of said first and second words and terms representing physical examinations or findings, anatomical locations and anatomical sites comprising a fourth individual group of words and terms and fourth group of individual SQL keys representing fourth information on individual physicians' identities and practices and specialties in said relational SQL units in said SQL databases and tables in said SQL Server;
j. computer server-automatic first sequential scans and matches of said fourth individual groups of words and terms with fifth words and terms representing a fifth information on individual physicians' identities and practices and specialties in said relational SQL units comprising said fifth words and terms representing said fifth information on individual physicians' identities and practices and specialties in said individual physicians' identities and practices and specialties tables related to anatomical sites or organ systems, laboratory results and anatomical locations in said relational SQL units and in related laboratory results, anatomical locations, anatomical sites and organ systems tables and second sequential scans and matches of first words and terms in said individual relational SQL units representing anatomical sites or organ systems, laboratory results and anatomical locations with second words and terms representing anatomical sites or organ systems, laboratory results and anatomical locations in said individual queries of individuals or individual groups of people;
k. computer server-automatic selections of said matches of said fourth individual groups of words and terms and said fifth individual groups of words and terms representing information on individual physicians' identities and practices and specialties represented by SQL keys in said relational SQL units related to said matches of said first and second words and terms representing anatomical sites or organ systems, laboratory results and anatomical locations; and
l. computer server-automatic stores of said matches of said fourth individual group of words and terms and said fifth individual group of words and terms representing information on individual physicians' identities and practices and specialties represented by SQL keys in said relational SQL units related to said matches of said first and second words and terms representing physical examinations or findings, anatomical locations and anatomical sites comprising a fifth individual group of words and terms and fifth group of individual SQL keys representing fifth information on individual physicians' identities and practices and specialties in said relational SQL units and represented by SQL keys in said SQL databases and tables in and manage by said SQL Server.

6. The system according to claim 1 wherein said computer server-automatic selections of said information on individual diagnoses represented by words and terms and related to SQL keys in said SQL databases and tables comprises computer server-automatic selections of individual diagnoses represented by words and terms and related to SQL keys in said SQL databases and tables and computer server-automatic selections of related treatments and differential diagnoses represented by related words and terms and related to SQL keys in said SQL databases and tables;

7. The system according to claim 1 wherein said computer server-executable algorithms for processing the relations of said words and terms in said relational SQL units and words and terms in individual queries in said SQL Server and in said memories of said computer server or servers comprise:
a. computer server-automatic and sequential scans and matches of said words and terms representing signs and symptoms and causes, provocatives, palliatives, severity of signs and symptoms and temporal factors of said signs and symptoms, anatomical locations, anatomical sites in said individual queries of individuals or individual groups of people with same, similar, equivalent or synonymous words and terms representing signs and symptoms, causes, causes, provocatives, palliatives, severity of signs and symptoms and temporal factors of said signs and symptoms, anatomical locations and anatomical sites and related to individual SQL keys and related first individual groups of individual SQL keys representing words and terms representing first information on individual diagnoses in said diagnoses tables in said individual relational SQL units in said individual SQL units;
b. computer server-automatic selections of matches of said words and terms in said individual queries with said words and terms in said individual relational SQL units and related to first individual SQL keys and words and terms representing a first information on individual diagnoses in said individual relational SQL units to be a first individual groups of words and terms and individual SQL keys representing said first information on individual diagnoses in said diagnoses tables;
c. computer server-automatic stores of said selections of said first individual groups of words and terms and said related individual SQL keys in said memories of said computer server or servers and said SQL databases and tables in said SQL Server;
d. computer server-automatic first sequential scans and matches of said first individual groups of words and terms with second words and terms representing a second information on individual diagnoses in said relational SQL units comprising said second words and terms representing said second information on individual diagnoses in said diagnoses tables related to reviews of systems, anatomical locations, anatomical sites in said relational SQL units and in related reviews of systems, anatomical locations, anatomical sites tables and second sequential scans and matches of first words and terms in said individual relational SQL units representing anatomical sites, reviews of systems and anatomical locations with second words and terms representing reviews of systems, anatomical locations and anatomical sites in said individual queries of individuals or individual groups of people;
e. computer server-automatic selections of said matches of said first individual groups of words and terms and said second words and terms representing information on individual diagnoses represented by SQL keys in said relational SQL units related to said matches of said first and second words and terms representing reviews of systems, anatomical locations and anatomical sites;
f. computer server-automatic stores of said matches of said first individual group of words and terms and said second individual group of words and terms representing information on individual diagnoses represented by SQL keys in said relational SQL units related to said matches of said first and second words and terms representing reviews of systems, anatomical locations and anatomical sites comprising a third individual group of words and terms and third group of individual SQL keys representing third information on individual diagnoses in said relational SQL units in said SQL databases and tables in said SQL Server;
g. computer server-automatic first sequential scans and matches of said third individual groups of words and terms with fourth words and terms representing a fourth information on individual diagnoses in said relational SQL units comprising said fourth words and terms representing said fourth information on individual diagnoses in said diagnoses tables related to anatomical sites, physical examinations or findings and anatomical locations in said relational SQL units and in related physical examinations or findings, anatomical locations, anatomical sites tables and second sequential scans and matches of first words and terms in said individual relational SQL units representing anatomical sites, physical examinations or findings and anatomical locations with second words and terms representing anatomical sites, physical examinations or findings and anatomical locations in said individual queries of individuals or individual groups of people;
h. computer server-automatic selections of said matches of said third individual groups of words and terms and said fourth individual groups of words and terms representing information on individual diagnoses represented by SQL keys in said relational SQL units related to said matches of said first and second words and terms representing physical examinations or findings, anatomical locations and anatomical sites;
i. computer server-automatic stores of said matches of said third individual group of words and terms and said fourth individual group of words and terms representing information on individual diagnoses represented by SQL keys in said relational SQL units related to said matches of said first and second words and terms representing physical examinations or findings, anatomical locations and anatomical sites comprising a fourth individual group of words and terms and fourth group of individual SQL keys representing fourth information on individual diagnoses in said relational SQL units in said SQL databases and tables in said SQL Server;
j. computer server-automatic first sequential scans and matches of said fourth individual groups of words and terms with fifth words and terms representing a fifth information on individual diagnoses in said relational SQL units comprising said fifth words and terms representing said fifth information on individual diagnoses in said diagnoses tables related to anatomical sites or organ systems, laboratory results and anatomical locations in said relational SQL units and in related laboratory results, anatomical locations, anatomical sites and organ systems tables and second sequential scans and matches of first words and terms in said individual relational SQL units representing anatomical sites or organ systems, laboratory results and anatomical locations with second words and terms representing anatomical sites or organ systems, laboratory results and anatomical locations in said individual queries of individuals or individual groups of people;
k. computer server-automatic selections of said matches of said fourth individual groups of words and terms and said fifth individual groups of words and terms representing information on individual diagnoses represented by SQL keys in said relational SQL units related to said matches of said first and second words and terms representing anatomical sites or organ systems, laboratory results and anatomical locations; and
l. computer server-automatic stores of said matches of said fourth individual group of words and terms and said fifth individual group of words and terms representing information on individual diagnoses represented by SQL keys in said relational SQL units related to said matches of said first and second words and terms representing physical examinations or findings, anatomical locations and anatomical sites comprising a fifth individual group of words and terms and fifth group of individual SQL keys representing fifth information on individual diagnoses in said relational SQL units and represented by SQL keys in said SQL databases and tables in and manage by said SQL Server.

8. In a system for computer server-deducing and displaying on the viewing screens information on individual physicians' identities and practices and specialties and individual diagnoses and related treatments and differential diagnoses represented by individual SQL keys in relational SQL units, a method for computer-automatically creating, generating and maintaining individual relational SQL units comprising relational SQL keys related to medical and surgical words, terms and phrases and synonyms and acronyms henceforth words and terms representing related signs and symptoms, reviews of systems, physical examinations or findings, laboratory results, anatomical locations, anatomical sites, diagnoses, differential diagnoses, treatments and individual physicians' identities and practices henceforth words and terms in the SQL databases and tables in the SQL Server in a functioning and operating computer server or servers possessing memories and said SQL Server enabled by the innovative computer programs and software for communicating with and commanding and providing instructions for said SQL Server to create, generate and manage said the SQL databases and tables and relational SQL units coupled to said SQL Server, at least one computer scripting language and said computer server or servers created and generated by physicians using computers, laptops, wireless, mobile communication equipment including smartphones possessing keyboards, application software and said viewing screens including touch-sensitive or touch screens enabled by Web browsers henceforth devices for accessing said SQL Servers and keyboarding said words and terms and/or retrieving said words and terms from the SQL databases and tables in said SQL Server into interactive drop-down lists and menus on the viewing screens enabled by said computer scripting language, Java Script, AJAX and the innovative computer programs and software for communicating with and commanding and providing instructions for said SQL Server to create, generate and manage said the SQL databases and tables and relational SQL units and submitting said selected words and terms to be related and compiled in said SQL Server and said memories of said computer server or servers for enabling computer server-deducing and displaying on said viewing screens information on individual physicians' identities and practices and specialties and individual diagnoses and related treatments and differential diagnoses on individual physicians' identities and practices and individual diagnoses and related treatments from said relational SQL units for responding to queries for said information from individuals or individual groups of people keyboarding said words and terms representing signs and symptoms, reviews of systems, physical examinations or findings, laboratory results, anatomical locations and anatomical sites and/or retrieving said words and terms from said SQL databases and tables into interactive drop-down lists and menus on said viewing screens enabled by said computer scripting language, Java Script, AJAX and said innovative computer programs and software for communicating with and commanding and providing instructions for said SQL Server to create, generate and manage said the SQL databases and tables and relational SQL units and selecting by clicking or touching interactive said words and terms on said viewing screens and submitting said selected words and terms to said SQL Server and said memories of said computer server or servers using said devices to access said computer servers to precisely deduce and display said information on said viewing screens from said relational SQL units for eliminate the random, tedious and time-consuming and costly processes for searching for and referring to physicians and to coordinate health and health-care services among said physicians and people and optimize health, preventive health-care, continuity of health-care, managing chronic diseases and excellence of health-care of people comprises:
a process for operating said computer servers possessing and operating memories, processors, at least a server operating system, a Windows Server, a SQL Server, computer scripting language, the innovative computer programs and software coupled to said SQL Server and at least one of said computer scripting languages, a Visual Studio and .Net, Java script, AJAX, HTML, XHTML, a Microsoft IIS, Apache, a Web browser and Web server;
a process for operating in said computer servers said innovative computer programs and software for creating and generating a plurality of individual interactive and adaptable related electronic templates, a plurality of interactive pop-up and/or drop-down lists and/or menus of words, terms, phrases, sentences, texts, synonyms, acronyms, texts, numbers, graphics, and word and term headers or headings comprising information and data on and relating to said diagnoses on diseases, disorders, health, health-care and health-care services in categories of chief complaints, signs and symptoms, reviews of systems, physical examinations or findings, laboratory results, anatomical locations, anatomical sites and organ systems, diagnoses, differential diagnoses, treatments, assessments and plans, recommendations, advices, referrals and follow-ups henceforth information and data use by physicians of about 85 medical and surgical specialties and practices, for creating, generating, expanding and improving SQL databases and tables comprising relational SQL keys related to said words and terms representing said in said SQL databases and tables in said SQL Server, for creating, compiling, pooling and relating relational information and data in said SQL databases and tables and relational SQL units, for repetitively scanning and checking for redundant duplicates or repeats, doubles in individual physicians' submissions related to individual diagnoses or individual syndromes or diagnoses in individual groups of diagnoses and related relational information and data in said SQL databases and tables, for removing said redundant duplicates or repeats, doubles from relational information and data from said SQL databases, tables and said relational SQL units and for not inserting said redundant duplicates or repeats, doubles into said relational information and data in said SQL databases and tables and relational SQL units, for creating, generating and maintaining said relational SQL units comprising relational SQL keys in said SQL databases and tables comprising plurality of said information and data tables, for creating, generating and maintaining individual unique relational SQL units comprising said relational SQL keys, for creating, generating and maintaining said unique relational SQL units comprising said relational SQL keys without redundant repeats and duplicates of SQL keys in said relational SQL units, for generating queries for said information on individual information on individual physicians' identities and practices and individual diagnoses and related treatments and differential diagnoses by people, for enabling said computer server or servers to process the relations of said words and terms and said relational SQL units and words and terms in said queries in said SQL Server and in said memories of said computer server or servers, for providing and instructing computer server or servers to execute algorithms for processing said relations of said words and terms and said relational SQL units and words and terms in said queries in said SQL Server and in said memories of said computer server or servers, for providing and instructing computer server or servers to sequentially scan and match said words and terms and said relational SQL units and words and terms in said queries, for providing and instructing computer server or servers to sequentially select said information on individual physicians' identities and practices and specialties individual diagnoses and related treatments and differential diagnoses on viewing screens and for providing and enabling said computer server or server to display said information on individual physicians' identities and practices and specialties individual diagnoses and related treatments and differential diagnoses on viewing screens;
a process for creating, generating, expanding and improving SQL databases and tables comprising relational SQL keys related to said words and terms representing signs and symptoms, reviews of systems, physical examinations or findings, laboratory results, anatomical locations, anatomical sites, diagnoses, differential diagnoses, treatments, assessments and plans, recommendations, advices, referrals and follow-ups in the SQL Server in said computer server or servers enabled by the innovative computer programs and software for communicating with and commanding and providing instructions for said SQL Server to create, generate and manage said the SQL databases and tables and relational SQL units coupled to said SQL Server, at least one computer scripting language and said computer server or servers by physicians using said devices for accessing said SQL Servers by keyboarding said words and terms and/or retrieving said words and terms from the SQL databases and tables into interactive drop-down lists and menus on the viewing screens enabled by said computer scripting language, Java Script, AJAX and the innovative computer programs and software for communicating with and commanding and providing instructions for said SQL Server to create, generate and manage said the SQL databases and tables and relational SQL units and submitting said selected words and terms to said SQL Server;
a process for further expanding and improving said SQL databases and tables comprising relational SQL keys related to said words and terms representing signs and symptoms, reviews of systems, physical examinations or findings, laboratory results, anatomical locations, anatomical sites, diagnoses, differential diagnoses, treatments and individual physicians' identities and practices and specialties in the SQL Server in a functioning and operating computer server or servers possessing memories and said SQL Server enabled by the innovative computer programs and software for communicating with and commanding and providing instructions for said SQL Server to create, generate and manage said the SQL databases and tables and relational SQL units coupled to said SQL Server, at least one computer scripting language and said computer server or servers by said individual physicians using said devices for accessing said SQL Servers by keyboarding said words and terms and/or retrieving said words and terms from the SQL databases and tables into interactive drop-down lists and menus on the viewing screens enabled by said computer scripting language, Java Script, AJAX and the innovative computer programs and software for communicating with and commanding and providing instructions for said SQL Server to create, generate and manage said the SQL databases and tables and relational SQL units and submitting said selected words and terms to said SQL Server;
a process for generating said SQL databases and tables comprising at least one signs and symptoms table, a plurality of causes, provocatives, palliatives, severity of signs and symptoms and temporal factors of said signs and symptoms tables, a plurality of reviews of systems tables, a plurality of physical examinations or findings tables, at least one laboratory results table, at least one anatomical locations table, a plurality of anatomical sites tables, a plurality of diagnoses tables, a plurality of differential diagnoses tables, a plurality of treatments tables, a plurality of synonyms and acronyms of said words and terms; a plurality of individual physicians and physicians' identities, practices and specialties tables in and manage by said SQL Server;
a process for generating relational SQL units comprising relational SQL keys related to said words and terms representing related signs and symptoms, reviews of systems, physical examinations or findings, laboratory results, anatomical locations, anatomical sites, diagnoses, differential diagnoses, treatments and individual physicians' identities and practices in said SQL databases and tables;
a process for creating, generating and maintaining said relational SQL units comprising relational SQL keys in said SQL databases and tables comprising at least one signs and symptoms table, a plurality of causes, provocatives, palliatives, severity of signs and symptoms and temporal factors of said signs and symptoms tables, a plurality of reviews of systems tables, a plurality of physical examinations or findings tables, at least one laboratory results table, at least one anatomical locations table, a plurality of anatomical sites tables, a plurality of diagnoses tables, a plurality of differential diagnoses tables, a plurality of treatments tables, a plurality of synonyms and acronyms of said words and terms;
a plurality of individual physicians and physicians' identities, practices and specialties tables;
a process for creating, generating and maintaining individual unique relational SQL units comprising said relational SQL keys;
a process for creating, generating and maintaining said unique relational SQL units comprising said relational SQL keys without redundant repeats and duplicates of SQL keys in said relational SQL units;
a process for generating queries for said information on individual information on individual physicians' identities and practices and individual diagnoses and related treatments by individuals or individual groups of people keyboarding said words and terms representing signs and symptoms, reviews of systems, physical examinations or findings, laboratory results, anatomical locations and anatomical sites and/or retrieving said words and terms from said SQL databases and tables into interactive drop-down lists and menus on said viewing screens enabled by said computer scripting language, Java Script, AJAX and said innovative computer programs and software for communicating with and commanding and providing instructions for said SQL Server to create, generate and manage said the SQL databases and tables and relational SQL units and selecting by clicking or touching interactive said words and terms on said viewing screens and submitting said selected words and terms to said SQL Server and said memories of said computer server or servers using said devices to access said computer servers;
a process for computer server-processing the relations of said words and terms and said relational SQL units and words and terms in said queries in said SQL Server and in said memories of said computer server or servers;
a process for computer server-executing algorithms for processing said relations of said words and terms and said relational SQL units and words and terms in said queries in said SQL Server and in said memories of said computer server or servers;
a process for computer server-sequentially scanning and matching said words and terms and said relational SQL units and words and terms in said queries in said SQL Server and in said memories of said computer server or servers;
a process for computer server-repetitively and sequentially scanning and matching said words and terms and said relational SQL units and words and terms in individuals' or individual groups of people's queries in said SQL Server and in said memories of said computer server or servers;
a process for computer server-automatically selecting of said information on individual physicians' identities and practices and specialties represented by SQL keys in said SQL databases and tables comprising words and terms representing physicians' identities and practices and specialties;
a process for computer server-automatically selecting of said information on individual diagnoses and related treatments represented by SQL keys in said SQL databases and tables comprising words and terms representing individual diagnoses and related treatments;
a process for computer server-automatically selecting of said information on individual diagnoses and generating related treatments and differential diagnoses represented by SQL keys in said SQL databases and tables comprising words and terms and SQL keys representing individual diagnoses;
a process for computer server-automatically displaying said selections comprising information on individual physicians' identities and practices and specialties on said viewing screens of said devices enabled by the Web browsers being used by said people;
a process for computer server-automatically displaying said selections comprising information on individual diagnoses on said viewing screens of said devices enabled by the Web browsers being used by said people;
a process for computer server-automatically displaying said selections comprising information on individual diagnoses and related treatments and differential diagnoses on said viewing screens of said devices enabled by the Web browsers being used by said people; and
a process for computer server-automatically displaying said selections and generations on the interactive 2-dimensional and 3-dimensional human figurines and images for displaying said selections and generations on the anatomical sites of said figurines and images enabled by said computer scripting language, Java Script, AJAX and said innovative computer programs and software and Web browsers.

9. The method according to claim 8 wherein said process for computer server-executing algorithms for processing said relations of said words and terms in said relational SQL units and words and terms in said queries in said SQL Server and in said memories of said computer server or servers comprises a process for computer server-executing at least one of the multiple computer server-executable algorithms for processing said relations of said words and terms and said relational SQL units and words and terms in said queries in said SQL Server and in said memories of said computer server or servers comprises:
a. a process for computer server-automatically and sequentially scanning and matching said words and terms representing signs and symptoms and causes, provocatives, palliatives, severity of signs and symptoms and temporal factors of said signs and symptoms, anatomical locations, anatomical sites in said individual queries of individuals or individual groups of people with same, similar, equivalent or synonymous words and terms representing signs and symptoms, causes, causes, provocatives, palliatives, severity of signs and symptoms and temporal factors of said signs and symptoms, anatomical locations and anatomical sites and related to individual SQL keys and related first individual groups of individual SQL keys representing words and terms representing first information on individual physicians' identities and practices and specialties in said individual physicians and physicians' identities, practices and specialties tables in said individual relational SQL units in said individual SQL units;
b. a process for computer server-automatically selecting matches of said words and terms in said individual queries with said words and terms in said individual relational SQL units and related to first individual SQL keys and words and terms representing a first information on individual physicians' identities and practices and specialties in said individual relational SQL units to be a first individual groups of words and terms and individual SQL keys representing said first information on individual physicians' identities and practices and specialties in said individual physicians and physicians' identities, practices and specialties;
c. a process for computer server-automatically storing selections of said first individual groups of words and terms and said related individual SQL keys in said memories of said computer server or servers and said SQL databases and tables in said SQL Server;
d. a process for computer server-automatically and first sequentially scanning and matching said first individual groups of words and terms with second words and terms representing a second information on individual physicians' identities and practices and specialties in said relational SQL units comprising said second words and terms representing said second information on individual physicians' identities and practices and specialties in said individual physicians' identities and practices and specialties tables related to reviews of systems, anatomical locations, anatomical sites in said relational SQL units and in related reviews of systems, anatomical locations, anatomical sites tables and second sequentially scanning and matching first words and terms in said individual relational SQL units representing anatomical sites, reviews of systems and anatomical locations with second words and terms representing reviews of systems, anatomical locations and anatomical sites in said individual queries of individuals or individual groups of people;
e. a process for computer server-automatically selecting said matches of said first individual groups of words and terms and said second words and terms representing information on individual physicians' identities and practices and specialties represented by SQL keys in said relational SQL units related to said matches of said first and second words and terms representing reviews of systems, anatomical locations and anatomical sites;
f. a process for computer server-automatically storing said matches of said first individual group of words and terms and said second individual group of words and terms representing information on individual physicians' identities and practices and specialties represented by SQL keys in said relational SQL units related to said matches of said first and second words and terms representing reviews of systems, anatomical locations and anatomical sites comprising a third individual group of words and terms and third group of individual SQL keys representing third information on individual physicians' identities and practices and specialties in said relational SQL units in said SQL databases and tables in said SQL Server;
g. a process for computer server-automatically and first sequentially scanning and matching said third individual groups of words and terms with fourth words and terms representing a fourth information on individual physicians' identities and practices and specialties in said relational SQL units comprising said fourth words and terms representing said fourth information on individual physicians' identities and practices and specialties in said individual physicians' identities and practices and specialties tables related to anatomical sites, physical examinations or findings and anatomical locations in said relational SQL units and in related physical examinations or findings, anatomical locations, anatomical sites tables and second sequentially scanning and matching first words and terms in said individual relational SQL units representing anatomical sites, physical examinations or findings and anatomical locations with second words and terms representing anatomical sites, physical examinations or findings and anatomical locations in said individual queries of individuals or individual groups of people;
h. a process for computer server-automatically selecting said matches of said third individual groups of words and terms and said fourth individual groups of words and terms representing information on individual physicians' identities and practices and specialties represented by SQL keys in said relational SQL units related to said matches of said first and second words and terms representing physical examinations or findings, anatomical locations and anatomical sites;
i. a process for computer server-automatically storing said matches of said third individual group of words and terms and said fourth individual group of words and terms representing information on individual physicians' identities and practices and specialties represented by SQL keys in said relational SQL units related to said matches of said first and second words and terms representing physical examinations or findings, anatomical locations and anatomical sites comprising a fourth individual group of words and terms and fourth group of individual SQL keys representing fourth information on individual physicians' identities and practices and specialties in said relational SQL units in said SQL databases and tables in said SQL Server;
j. a process for computer server-automatically and first sequentially scanning and matching said fourth individual groups of words and terms with fifth words and terms representing a fifth information on individual physicians' identities and practices and specialties in said relational SQL units comprising said fifth words and terms representing said fifth information on individual physicians' identities and practices and specialties in said individual physicians' identities and practices and specialties tables related to anatomical sites or organ systems, laboratory results and anatomical locations in said relational SQL units and in related laboratory results, anatomical locations, anatomical sites and organ systems tables and second sequentially scanning and matching first words and terms in said individual relational SQL units representing anatomical sites or organ systems, laboratory results and anatomical locations with second words and terms representing anatomical sites or organ systems, laboratory results and anatomical locations in said individual queries of individuals or individual groups of people;
k. a process for computer server-automatically selecting said matches of said fourth individual groups of words and terms and said fifth individual groups of words and terms representing information on individual physicians' identities and practices and specialties represented by SQL keys in said relational SQL units related to said matches of said first and second words and terms representing anatomical sites or organ systems, laboratory results and anatomical locations; and
l. a process for computer server-automatically storing said matches of said fourth individual group of words and terms and said fifth individual group of words and terms representing information on individual physicians' identities and practices and specialties represented by SQL keys in said relational SQL units related to said matches of said first and second words and terms representing physical examinations or findings, anatomical locations and anatomical sites comprising a fifth individual group of words and terms and fifth group of individual SQL keys representing fifth information on individual physicians' identities and practices and specialties in said relational SQL units and represented by SQL keys in said SQL databases and tables in and manage by said SQL Server.

10. The method according to claim 8 said a process for computer server-automatically displaying said selections comprising information on individual physicians' identities and practices and specialties on said viewing screens of said devices enabled by the Web browsers being used by said people comprise a process for retrieving from said SQL databases and tables and displaying on said viewing screens said fifth individual group of words and terms and fifth group of individual SQL keys representing fifth information on individual physicians' identities and practices and specialties.

11. The method according to claim 8 wherein said process for computer server-executing algorithms for processing said relations of said words and terms and said relational SQL units and words and terms in said queries in said SQL Server and in said memories of said computer server or servers comprises a process for computer server-executing an algorithm for processing said relations of said words and terms and said relational SQL units and words and terms in said queries in said SQL Server and in said memories of said computer server or servers comprises:
a. a process for computer server-automatically and sequentially scanning and matching said words and terms representing signs and symptoms and causes, provocatives, palliatives, severity of signs and symptoms and temporal factors of said signs and symptoms, anatomical locations, anatomical sites in said individual queries of individuals or individual groups of people with same, similar, equivalent or synonymous words and terms representing signs and symptoms, causes, causes, provocatives, palliatives, severity of signs and symptoms and temporal factors of said signs and symptoms, anatomical locations and anatomical sites and related to individual SQL keys and related first individual groups of individual SQL keys representing words and terms representing first information on individual diagnoses in said diagnoses tables in said individual relational SQL units in said individual SQL units;
b. a process for computer server-automatically selecting matches of said words and terms in said individual queries with said words and terms in said individual relational SQL units and related to first individual SQL keys and words and terms representing a first information on individual diagnoses in said individual relational SQL units to be a first individual groups of words and terms and individual SQL keys representing said first information on individual diagnoses in said individual physicians and physicians' identities, practices and specialties tables;
c. a process for computer server-automatically storing selections of said first individual groups of words and terms and said related individual SQL keys in said memories of said computer server or servers and said SQL databases and tables in said SQL Server;
d. a process for computer server-automatically and first sequentially scanning and matching said first individual groups of words and terms with second words and terms representing a second information on individual diagnoses in said relational SQL units comprising said second words and terms representing said second information on individual diagnoses in said individual diagnoses tables related to reviews of systems, anatomical locations, anatomical sites in said relational SQL units and in related reviews of systems, anatomical locations, anatomical sites tables and second sequentially scanning and matching first words and terms in said individual relational SQL units representing anatomical sites, reviews of systems and anatomical locations with second words and terms representing reviews of systems, anatomical locations and anatomical sites in said individual queries of individuals or individual groups of people;
e. a process for computer server-automatically selecting said matches of said first individual groups of words and terms and said second words and terms representing information on individual diagnoses represented by SQL keys in said relational SQL units related to said matches of said first and second words and terms representing reviews of systems, anatomical locations and anatomical sites;
f. a process for computer server-automatically storing said matches of said first individual group of words and terms and said second individual group of words and terms representing information on individual diagnoses represented by SQL keys in said relational SQL units related to said matches of said first and second words and terms representing reviews of systems, anatomical locations and anatomical sites comprising a third individual group of words and terms and third group of individual SQL keys representing third information on individual diagnoses in said relational SQL units in said SQL databases and tables in said SQL Server;
g. a process for computer server-automatically and first sequentially scanning and matching said third individual groups of words and terms with fourth words and terms representing a fourth information on individual diagnoses in said relational SQL units comprising said fourth words and terms representing said fourth information on individual diagnoses in said diagnoses tables related to anatomical sites, physical examinations or findings and anatomical locations in said relational SQL units and in related physical examinations or findings, anatomical locations, anatomical sites tables and second sequentially scanning and matching first words and terms in said individual relational SQL units representing anatomical sites, physical examinations or findings and anatomical locations with second words and terms representing anatomical sites, physical examinations or findings and anatomical locations in said individual queries of individuals or individual groups of people;
h. a process for computer server-automatically selecting said matches of said third individual groups of words and terms and said fourth individual groups of words and terms representing information on individual diagnoses represented by SQL keys in said relational SQL units related to said matches of said first and second words and terms representing physical examinations or findings, anatomical locations and anatomical sites;
i. a process for computer server-automatically storing said matches of said third individual group of words and terms and said fourth individual group of words and terms representing information on individual diagnoses represented by SQL keys in said relational SQL units related to said matches of said first and second words and terms representing physical examinations or findings, anatomical locations and anatomical sites comprising a fourth individual group of words and terms and fourth group of individual SQL keys representing fourth information on individual diagnoses in said relational SQL units in said SQL databases and tables in said SQL Server;
j. a process for computer server-automatically and first sequentially scanning and matching said fourth individual groups of words and terms with fifth words and terms representing a fifth information on individual diagnoses in said relational SQL units comprising said fifth words and terms representing said fifth information on individual diagnoses in said diagnoses tables related to anatomical sites or organ systems, laboratory results and anatomical locations in said relational SQL units and in related laboratory results, anatomical locations, anatomical sites and organ systems tables and second sequentially scanning and matching first words and terms in said individual relational SQL units representing anatomical sites or organ systems, laboratory results and anatomical locations with second words and terms representing anatomical sites or organ systems, laboratory results and anatomical locations in said individual queries of individuals or individual groups of people;
k. a process for computer server-automatically selecting said matches of said fourth individual groups of words and terms and said fifth individual groups of words and terms representing information on individual diagnoses represented by SQL keys in said relational SQL units related to said matches of said first and second words and terms representing anatomical sites or organ systems, laboratory results and anatomical locations; and
l. a process for computer server-automatically storing said matches of said fourth individual group of words and terms and said fifth individual group of words and terms representing information on individual diagnoses represented by SQL keys in said relational SQL units related to said matches of said first and second words and terms representing physical examinations or findings, anatomical locations and anatomical sites comprising a fifth individual group of words and terms and fifth group of individual SQL keys representing fifth information on individual diagnoses in said relational SQL units and represented by SQL keys in said SQL databases and tables in and manage by said SQL Server.

12. The method according to claim 8 wherein said process for computer server-automatically displaying said selections comprising information on individual diagnoses on said viewing screens of said devices enabled by the Web browsers being used by said people comprises a process for retrieving from said SQL databases and tables and displaying on said viewing screens said fifth individual group of words and terms and fifth group of individual SQL keys representing fifth information on individual diagnoses.

13. The method according to claim 8 wherein said process for computer server-automatically displaying said selections comprising information on individual diagnoses and related treatments and differential diagnoses on said viewing screens of said devices enabled by the Web browsers being used by said people comprises a process for retrieving from said SQL databases and tables and displaying on said viewing screens said fifth individual group of words and terms and fifth group of individual SQL keys representing fifth information on individual diagnoses and related words and terms representing said treatments and differential diagnoses related to said individual diagnoses and related SQL keys related to said treatments and differential diagnoses related to said individual diagnoses in said treatments SQL databases and tables and differential diagnoses SQL databases and tables.

14. The method according to claim 8 wherein said process for computer server-automatically displaying said selections comprising information on individual diagnoses and related treatments and differential diagnoses on said viewing screens of said devices enabled by the Web browsers being used by said people comprises a process for retrieving from said SQL databases and tables and displaying on said viewing screens said fifth individual group of words and terms and fifth group of individual SQL keys representing fifth information on individual diagnoses and related words and terms representing said treatments and differential diagnoses and related individual physicians' identities, practices and specialties related to said individual diagnoses and related SQL keys related to said treatments and differential diagnoses related to said individual diagnoses in said treatments SQL databases and tables, differential diagnoses SQL databases and tables and physicians' identities, practices and specialties SQL databases and tables.

15. The method according to claim 8 said process for computer server-automatically displaying said selections comprising information on individual diagnoses on said viewing screens comprise a process for retrieving from said SQL databases and tables and displaying on said viewing screens said fifth individual group of words and terms and fifth group of individual SQL keys representing fifth information on individual diagnoses.

16. In a system for computer server-deducing and displaying on the viewing screens information on individual physicians' identities and practices and specialties and individual diagnoses and related treatments and differential diagnoses represented by individual SQL keys in relational SQL units, a method for computer server-automatically operating and executing computer server-executable algorithms generated and provided by innovative computer programs and software for communicating with, commanding and providing computer server-executable algorithms for a functioning and operating computer server or servers possessing memories and operating said innovative computer programs and software coupled to at least one computer scripting language and a SQL Server for computer server-automatically deducing and displaying on the viewing screens information on individual physicians' identities and practices and specialties and individual diagnoses and related treatments and differential diagnoses from relational SQL units comprising relational SQL keys representing said information on said individual physicians, diagnoses and treatments in the SQL databases and tables comprising said relational SQL keys related to medical and surgical words, terms and phrases and synonyms and acronyms henceforth words and terms representing related signs and symptoms, reviews of systems, physical examinations or findings, laboratory results, anatomical locations, anatomical sites, diagnoses, differential diagnoses, treatments and said individual physicians' identities and practices created, generated and submitted to and compiled in said SQL databases and tables in and manage by the SQL Server in said computer server or servers by said individual physicians from scanning and matching said relational SQL units with individuals or individual groups of people's queries comprising words and terms representing signs and symptoms, reviews of systems, physical examinations or findings, laboratory results, anatomical locations and anatomical sites in said memories of said computer server or servers and said SQL databases for precisely deducing said information from said relational SQL units in said computer server or servers and displaying said information on said viewing screens of said devices for eliminating the random, tedious and time-consuming and costly processes for searching for and referring to physicians and coordinating health and health-care services among said physicians and people and optimizing health, preventive health-care, continuity of health-care, managing chronic diseases and health-care of people comprises:
a process for operating said computer servers possessing and operating memories, processors, at least a server operating system, a Windows Server, a SQL Server, computer scripting language, the innovative computer programs and software coupled to said SQL Server and at least one of said computer scripting languages, a Visual Studio and .Net, Java script, AJAX, HTML, XHTML, a Microsoft IIS, Apache, a Web browser and Web server;
a process for operating in said computer servers said innovative computer programs and software for creating and generating a plurality of individual interactive and adaptable related electronic templates, a plurality of interactive pop-up and/or drop-down lists and/or menus of words, terms, phrases, sentences, texts, synonyms, acronyms, texts, numbers, graphics, and word and term headers or headings comprising information and data on and relating to said diagnoses on diseases, disorders, health, health-care and health-care services in categories of chief complaints, signs and symptoms, reviews of systems, physical examinations or findings, laboratory results, anatomical locations, anatomical sites and organ systems, diagnoses, differential diagnoses, treatments, assessments and plans, recommendations, advices, referrals and follow-ups henceforth information and data use by physicians of about 85 medical and surgical specialties and practices, for creating, generating, expanding and improving SQL databases and tables comprising relational SQL keys related to said words and terms representing said in said SQL databases and tables in said SQL Server, for creating, compiling, pooling and relating relational information and data in said SQL databases and tables and relational SQL units, for repetitively scanning and checking for redundant duplicates or repeats, doubles in individual physicians' submissions related to individual diagnoses or individual syndromes or diagnoses in individual groups of diagnoses and related relational information and data in said SQL databases and tables, for removing said redundant duplicates or repeats, doubles from relational information and data from said SQL databases, tables and said relational SQL units and for not inserting said redundant duplicates or repeats, doubles into said relational information and data in said SQL databases and tables and relational SQL units, for creating, generating and maintaining said relational SQL units comprising relational SQL keys in said SQL databases and tables comprising plurality of said information and data tables, for creating, generating and maintaining individual unique relational SQL units comprising said relational SQL keys, for creating, generating and maintaining said unique relational SQL units comprising said relational SQL keys without redundant repeats and duplicates of SQL keys in said relational SQL units, for generating queries for said information on individual information on individual physicians' identities and practices and individual diagnoses and related treatments and differential diagnoses by people, for enabling said computer server or servers to process the relations of said words and terms and said relational SQL units and words and terms in said queries in said SQL Server and in said memories of said computer server or servers, for providing and instructing computer server or servers to execute algorithms for processing said relations of said words and terms and said relational SQL units and words and terms in said queries in said SQL Server and in said memories of said computer server or servers, for providing and instructing computer server or servers to sequentially scan and match said words and terms and said relational SQL units and words and terms in said queries, for providing and instructing computer server or servers to sequentially select said information on individual physicians' identities and practices and specialties individual diagnoses and related treatments and differential diagnoses on viewing screens and for providing and enabling said computer server or server to display said information on individual physicians' identities and practices and specialties individual diagnoses and related treatments and differential diagnoses on viewing screens;
a process for creating, generating, expanding and improving SQL databases and tables comprising relational SQL keys related to said words and terms representing signs and symptoms, reviews of systems, physical examinations or findings, laboratory results, anatomical locations, anatomical sites, diagnoses, differential diagnoses, treatments, assessments and plans, recommendations, advices, referrals and follow-ups in the SQL Server in said computer server or servers enabled by the innovative computer programs and software for communicating with and commanding and providing instructions for said SQL Server to create, generate and manage said the SQL databases and tables and relational SQL units coupled to said SQL Server, at least one computer scripting language and said computer server or servers by physicians using said devices for accessing said SQL Servers by keyboarding said words and terms and/or retrieving said words and terms from the SQL databases and tables into interactive drop-down lists and menus on the viewing screens enabled by said computer scripting language, Java Script, AJAX and the innovative computer programs and software for communicating with and commanding and providing instructions for said SQL Server to create, generate and manage said the SQL databases and tables and relational SQL units and submitting said selected words and terms to said SQL Server;
a process for further expanding and improving said SQL databases and tables comprising relational SQL keys related to said words and terms representing signs and symptoms, reviews of systems, physical examinations or findings, laboratory results, anatomical locations, anatomical sites, diagnoses, differential diagnoses, treatments and individual physicians' identities and practices and specialties in the SQL Server in a functioning and operating computer server or servers possessing memories and said SQL Server enabled by the innovative computer programs and software for communicating with and commanding and providing instructions for said SQL Server to create, generate and manage said the SQL databases and tables and relational SQL units coupled to said SQL Server, at least one computer scripting language and said computer server or servers by said individual physicians using said devices for accessing said SQL Servers by keyboarding said words and terms and/or retrieving said words and terms from the SQL databases and tables into interactive drop-down lists and menus on the viewing screens enabled by said computer scripting language, Java Script, AJAX and the innovative computer programs and software for communicating with and commanding and providing instructions for said SQL Server to create, generate and manage said the SQL databases and tables and relational SQL units and submitting said selected words and terms to said SQL Server;
a process for generating said SQL databases and tables comprising at least one signs and symptoms table, a plurality of causes, provocatives, palliatives, severity of signs and symptoms and temporal factors of said signs and symptoms tables, a plurality of reviews of systems tables, a plurality of physical examinations or findings tables, at least one laboratory results table, at least one anatomical locations table, a plurality of anatomical sites tables, a plurality of diagnoses tables, a plurality of differential diagnoses tables, a plurality of treatments tables, a plurality of synonyms and acronyms of said words and terms; a plurality of individual physicians and physicians' identities, practices and specialties tables in and manage by said SQL Server;
a process for generating relational SQL units comprising relational SQL keys related to said words and terms representing related signs and symptoms, reviews of systems, physical examinations or findings, laboratory results, anatomical locations, anatomical sites, diagnoses, differential diagnoses, treatments and individual physicians' identities and practices, in said SQL databases and tables;
a process for creating, generating and maintaining said relational SQL units comprising relational SQL keys in said SQL databases and tables comprising at least one signs and symptoms table, a plurality of causes, provocatives, palliatives, severity of signs and symptoms and temporal factors of said signs and symptoms tables, a plurality of reviews of systems tables, a plurality of physical examinations or findings tables, at least one laboratory results table, at least one anatomical locations table, a plurality of anatomical sites tables, a plurality of diagnoses tables, a plurality of differential diagnoses tables, a plurality of treatments tables, a plurality of synonyms and acronyms of said words and terms; a plurality of individual physicians and physicians' identities, practices and specialties tables;
a process for creating, generating and maintaining individual unique relational SQL units comprising said relational SQL keys;
a process for creating, generating and maintaining said unique relational SQL units comprising said relational SQL keys without redundant repeats and duplicates of SQL keys in said relational SQL units;
a process for generating queries for said information on individual information on individual physicians' identities and practices and individual diagnoses and related treatments by individuals or individual groups of people keyboarding said words and terms representing signs and symptoms, reviews of systems, physical examinations or findings, laboratory results, anatomical locations and anatomical sites and/or retrieving said words and terms from said SQL databases and tables into interactive drop-down lists and menus on said viewing screens enabled by said computer scripting language, Java Script, AJAX and said innovative computer programs and software for communicating with and commanding and providing instructions for said SQL Server to create, generate and manage said the SQL databases and tables and relational SQL units and selecting by clicking or touching interactive said words and terms on said viewing screens and submitting said selected words and terms to said SQL Server and said memories of said computer server or servers using said devices to access said computer servers;
a process for computer server-processing the relations of said words and terms and said relational SQL units and words and terms in said queries in said SQL Server and in said memories of said computer server or servers;
a process for computer server-executing algorithms for processing said relations of said words and terms and said relational SQL units and words and terms in said queries in said SQL Server and in said memories of said computer server or servers;
a process for computer server-sequentially scanning and matching said words and terms and said relational SQL units and words and terms in said queries in said SQL Server and in said memories of said computer server or servers;
a process for computer server-repetitively and sequentially scanning and matching said words and terms and said relational SQL units and words and terms in individuals' or individual groups of people's queries in said SQL Server and in said memories of said computer server or servers;
a process for computer server-automatically selecting of said information on individual physicians' identities and practices and specialties represented by SQL keys in said SQL databases and tables comprising words and terms representing physicians' identities and practices and specialties;
a process for computer server-automatically selecting of said information on individual diagnoses and related treatments represented by SQL keys in said SQL databases and tables comprising words and terms representing individual diagnoses and related treatments;
a process for computer server-automatically selecting of said information on individual diagnoses and generating related treatments and differential diagnoses represented by SQL keys in said SQL databases and tables comprising words and terms and SQL keys representing individual diagnoses;
a process for computer server-automatically displaying said selections comprising information on individual physicians' identities and practices and specialties on said viewing screens of said devices enabled by the Web browsers being used by said people;
a process for computer server-automatically displaying said selections comprising information on individual diagnoses on said viewing screens of said devices enabled by the Web browsers being used by said people;
a process for computer server-automatically displaying said selections comprising information on individual diagnoses and related treatments and differential diagnoses on said viewing screens of said devices enabled by the Web browsers being used by said people; and
a process for computer server-automatically displaying said selections and generations on the interactive 2-dimensional and 3-dimensional human figurines and images for displaying said selections and generations on the anatomical sites of said figurines and images enabled by said computer scripting language, Java Script, AJAX and said innovative computer programs and software and Web browsers.
